(19) United States
(12) Patent Application Publication
(10) Pub. No.: US 2024/0065289 A1
(43) Pub. Date: Feb. 29, 2024

(54) EXTRACTS FROM OIL SEEDS AND METHODS FOR PROCESSING OIL SEEDS

(71) Applicant: Apparo, Inc., Eden Prairie, MN (US)

(72) Inventors: Ian Mackay, Eden Prairie, MN (US); Karl James Greden, Minneapolis, MN (US); Emily Weinand, Monticello, MN (US); Kevin Alexander Toboja, Minneapolis, MN (US); J. David Mingus, New Hope, MN (US)

(21) Appl. No.: 18/259,677

(22) PCT Filed: Nov. 30, 2021
(86) PCT No.: PCT/US2021/061202

§ 371 Date: Jun. 28, 2023

Related U.S. Application Data
(60) Provisional application No. 63/119,065, filed on Nov. 30, 2020.

(51) Int. Cl. A23J 1/14; A23L 27/30

(52) U.S. Cl. CPC A23J 1/14; A23L 27/30; A23V 2300/10; A23V 2300/14

(57) ABSTRACT

Methods for extracting materials from oil seeds are disclosed. An example method may include extracting a material from an oil seed with an extraction solution to form a mixture. The extraction solution may be free of an organic solvent. The method may also include filtering the mixture into a retentate and a permeate. The method may also include drying the retentate.

### CROSS REFERENCE TO RELATED APPLICATIONS

This application claims the benefit of and priority to U.S. Provisional Patent Application Ser. No. 63/119,065 filed on Nov. 30, 2020, the disclosure of which is hereby incorporated by reference.

### TECHNICAL FIELD

The present disclosure pertains to extracts from oils seeds and methods for processing oil seeds.

### BACKGROUND

A number of methods for processing oil seeds are known. Of these methods, each has certain advantages and disadvantages. There is an ongoing need for new and different methods for processing oil seeds.

### BRIEF SUMMARY

This disclosure provides methods for processing oil seeds. A method for extracting materials from oil seeds is disclosed. The method comprises: extracting a material from an oil seed with an extraction solution to form a mixture; wherein the extraction solution is free of an organic solvent; filtering the mixture into a retentate and a permeate; and drying the retentate.

Alternatively or additionally to any of the embodiments above, further comprising de-hulling the oil seed.

Alternatively or additionally to any of the embodiments above, further comprising cold pressing the oil seed.

Alternatively or additionally to any of the embodiments above, further comprising milling the de-hulled oil seed.

Alternatively or additionally to any of the embodiments above, the extraction solution includes water.

Alternatively or additionally to any of the embodiments above, the extraction solution includes a salt.

Alternatively or additionally to any of the embodiments above, the extraction solution includes an acid.

Alternatively or additionally to any of the embodiments above, further comprising separating the mixture into an aqueous phase and a wet meal.

Alternatively or additionally to any of the embodiments above, separating the mixture into an aqueous phase and a wet meal includes decanting.

Alternatively or additionally to any of the embodiments above, further comprising removing a seed oil from the aqueous phase.

Alternatively or additionally to any of the embodiments above, further comprising centrifuging the aqueous phase.

Alternatively or additionally to any of the embodiments above, centrifuging the aqueous phase includes separating oil from the aqueous phase.

Alternatively or additionally to any of the embodiments above, filtering the mixture includes ultrafiltration.

Alternatively or additionally to any of the embodiments above, filtering the mixture includes diafiltration.

Alternatively or additionally to any of the embodiments above, drying the retentate includes evaporating the retentate.

Alternatively or additionally to any of the embodiments above, drying the retentate includes spray drying the retentate.

Alternatively or additionally to any of the embodiments above, the retentate includes soluble protein.

Alternatively or additionally to any of the embodiments above, the retentate includes low molecular weight protein.

Alternatively or additionally to any of the embodiments above, further comprising filtering the permeate.

Alternatively or additionally to any of the embodiments above, filtering the permeate includes nanofiltration.

Alternatively or additionally to any of the embodiments above, filtering the permeate separates the permeate into a second permeate and a second retentate.

Alternatively or additionally to any of the embodiments above, further comprising drying the second retentate.

Alternatively or additionally to any of the embodiments above, drying the second retentate includes evaporating the second retentate.

Alternatively or additionally to any of the embodiments above, drying the second retentate includes spray drying the second retentate.

Alternatively or additionally to any of the embodiments above, the second retentate includes chlorogenic acid.

Alternatively or additionally to any of the embodiments above, further comprising passing the second permeate through a reverse osmosis membrane.

Alternatively or additionally to any of the embodiments above, passing the second permeate through a reverse osmosis membrane produces purified water.

Alternatively or additionally to any of the embodiments above, passing the second permeate through a reverse osmosis membrane produces a brine solution.

Alternatively or additionally to any of the embodiments above, further comprising extracting the wet meal.

Alternatively or additionally to any of the embodiments above, extracting the wet meal is an organic solvent-free extraction.

Alternatively or additionally to any of the embodiments above, further comprising separating the wet meal into a second aqueous phase and a second wet meal.

Alternatively or additionally to any of the embodiments above, separating the wet meal into a second aqueous phase and a second wet meal includes decanting.

Alternatively or additionally to any of the embodiments above, further comprising centrifuging the second aqueous phase.

Alternatively or additionally to any of the embodiments above, centrifuging the second aqueous phase includes separating oil from the second aqueous phase.

Alternatively or additionally to any of the embodiments above, further comprising precipitating the second aqueous phase.

Alternatively or additionally to any of the embodiments above, precipitating the second aqueous phase includes lowering the pH of the second aqueous phase.

Alternatively or additionally to any of the embodiments above, further comprising separating precipitated material from the second aqueous phase.

Alternatively or additionally to any of the embodiments above, separating precipitated material from the second aqueous phase includes decanting.

Alternatively or additionally to any of the embodiments above, further comprising washing the precipitated material.

Alternatively or additionally to any of the embodiments above, further comprising filtering the second aqueous phase into a third retentate and a third permeate.

Alternatively or additionally to any of the embodiments above, further comprising passing the third permeate through a reverse osmosis membrane.

Alternatively or additionally to any of the embodiments above, passing the third permeate through a reverse osmosis membrane produces purified water.

Alternatively or additionally to any of the embodiments above, passing the third permeate through a reverse osmosis membrane produces a brine solution.

Alternatively or additionally to any of the embodiments above, further comprising drying the third retentate, the precipitate, or both.

Alternatively or additionally to any of the embodiments above, drying the third retentate, the precipitate, or both includes flash drying the third retentate.

Alternatively or additionally to any of the embodiments above, the third retentate, the precipitate, or both includes insoluble protein.

Alternatively or additionally to any of the embodiments above, the third retentate, the precipitate, or both includes high molecular weight protein.

Alternatively or additionally to any of the embodiments above, the oil seed includes a sunflower seed.

A method for extracting a plurality of target materials from oil seeds is disclosed. The method comprises: performing a first extraction on an oil seed material to form an aqueous phase and a solid phase, wherein the first extraction is an organic solvent-free extraction; filtering the aqueous phase to form a retentate and a permeate; drying the retentate, wherein the dried retentate comprises a first target material; filtering the permeate to form a second retentate; drying the second retentate, wherein the dried second retentate comprises a second target material.

Alternatively or additionally to any of the embodiments above, the first target material includes a protein.

Alternatively or additionally to any of the embodiments above, the second target material includes chlorogenic acid.

Alternatively or additionally to any of the embodiments above, further comprising adding a precipitating material to the permeate to form a precipitate.

Alternatively or additionally to any of the embodiments above, the precipitating material includes calcium chloride.

Alternatively or additionally to any of the embodiments above, the precipitate includes phytic acid.

A method for extracting a plurality of target materials from oil seeds is disclosed. The method comprises: performing a first extraction on an oil seed material by adding water and a salt to the oil seed material, wherein performing the first extraction forms an aqueous phase and a solid phase; filtering the aqueous phase to form a retentate and a permeate; drying the retentate, wherein the dried retentate comprises a first target material; filtering the permeate to form a second retentate; drying the second retentate, wherein the dried second retentate comprises a second target material.

Alternatively or additionally to any of the embodiments above, the first target material includes a protein.

Alternatively or additionally to any of the embodiments above, the second target material includes chlorogenic acid.

Alternatively or additionally to any of the embodiments above, further comprising adding a precipitating material to the permeate to form a precipitate.

Alternatively or additionally to any of the embodiments above, the precipitating material includes calcium chloride.

Alternatively or additionally to any of the embodiments above, the precipitate includes phytic acid.

A food product is disclosed. The food product comprises: an emulsion; and a sunflower-based emulsifier mixed with the emulsion.

A food product is disclosed. The food product comprises: a liquid; and a soluble sunflower protein dissolved in the liquid.

A method for extracting a sweet-tasting protein from sunflower seeds is disclosed. The method comprises: extracting a material from sunflower seeds with an extraction solution to form a mixture; wherein the extraction solution is free of an organic solvent; filtering the mixture into a retentate and a permeate; and drying the retentate to extract a sweet-tasting protein.

A method for extracting a protein from sunflower seeds is disclosed. The method comprises: extracting a material from sunflower seeds with an extraction solution to form a mixture; wherein the extraction solution is free of an organic solvent; filtering the mixture into a retentate and a permeate; and drying the retentate to form a protein having a native three-dimensional conformation.

A method for extracting a plurality of materials from oil seeds is disclosed. The method comprises: extracting a material from an oil seed with an extraction solution to form a mixture; wherein the extraction solution is free of an organic solvent; filtering the mixture into a retentate and a permeate; drying the retentate to form a first material; filtering the permeate into a second retentate and a second permeate; drying the second retentate to form a second material; and wherein at least one of the first material and the second material includes a nutraceutical.

A method for extracting materials from oil seeds is disclosed. The method comprises: mixing an extraction solution to a quantity of dehulled and milled oil seeds to form a mixture; wherein the extraction solution includes water and a salt; wherein the pH of the extraction solution is 3 to 6; extracting the mixture at a temperature in the range of 10-93° C. for 0.5 to 6 hours to form an extracted mixture; filtering the extracted mixture into a retentate and a permeate; and drying the retentate.

A method for extracting materials from oil seeds is disclosed. The method comprises: mixing an extraction solution to a quantity of dehulled, pressed, and milled oil seeds to form a mixture; wherein the extraction solution includes water and a salt; wherein the pH of the extraction solution is 3 to 6; extracting the mixture at a temperature in the range of 10-93° C. for 0.5 to 6 hours to form an extracted mixture; filtering the extracted mixture into a retentate and a permeate; and drying the retentate.

A method for extracting a plurality of target materials from oil seeds is disclosed. The method comprises: performing a first extraction on an oil seed material to form an aqueous phase and a solid phase, wherein the first extraction is an organic solvent-free extraction; filtering the aqueous phase to form a retentate and a permeate; drying the retentate, wherein the dried retentate comprises a first target material; filtering the permeate to form a second retentate; drying the second retentate, wherein the dried second retentate comprises a second target material.

Alternatively or additionally to any of the embodiments above, the first target material includes a first protein.

Alternatively or additionally to any of the embodiments above, the first protein includes an insoluble protein.

Alternatively or additionally to any of the embodiments above, the second target material includes a second protein.

Alternatively or additionally to any of the embodiments above, the second protein includes a soluble protein.

Alternatively or additionally to any of the embodiments above, filtering the permeate to form a second retentate includes forming a second permeate.

Alternatively or additionally to any of the embodiments above, further comprising filtering the second permeate to form a third retentate.

Alternatively or additionally to any of the embodiments above, further comprising drying the third retentate, wherein the dried third retentate comprises a third target material.

Alternatively or additionally to any of the embodiments above, the third target material includes chlorogenic acid.

Alternatively or additionally to any of the embodiments above, further comprising adding a precipitating material to the permeate, the second permeate, or both to form a precipitate.

Alternatively or additionally to any of the embodiments above, the precipitating material includes calcium chloride.

Alternatively or additionally to any of the embodiments above, wherein the precipitate includes phytic acid.

A method for extracting materials from oil seeds is disclosed. The method comprises: extracting a material from an oil seed with an extraction solution to form a mixture; wherein the extraction solution is free of an organic solvent; filtering the mixture into a retentate and a permeate; and drying the retentate.

Alternatively or additionally to any of the embodiments above, the extraction solution includes water and salt.

Alternatively or additionally to any of the embodiments above, further comprising separating the mixture into an aqueous phase and a wet meal by decanting.

Alternatively or additionally to any of the embodiments above, further comprising removing a seed oil from the aqueous phase.

Alternatively or additionally to any of the embodiments above, filtering the mixture includes ultrafiltration.

Alternatively or additionally to any of the embodiments above, the retentate includes soluble protein.

Alternatively or additionally to any of the embodiments above, further comprising filtering the permeate into a second permeate and a second retentate.

Alternatively or additionally to any of the embodiments above, filtering the permeate includes nanofiltration.

Alternatively or additionally to any of the embodiments above, the second retentate includes chlorogenic acid.

Alternatively or additionally to any of the embodiments above, further comprising passing the second permeate through a reverse osmosis membrane.

Alternatively or additionally to any of the embodiments above, further comprising extracting the wet meal and separating the wet meal into a second aqueous phase and a second wet meal.

Alternatively or additionally to any of the embodiments above, further comprising precipitating the second aqueous phase and separating a precipitated material from the aqueous phase.

Alternatively or additionally to any of the embodiments above, further comprising filtering the second aqueous phase into a third retentate and a third permeate.

Alternatively or additionally to any of the embodiments above, the third retentate includes insoluble protein.

A method for extracting a plurality of target materials from oil seeds is disclosed. The method comprises: performing a first extraction on an oil seed material to form an aqueous phase and a solid phase, wherein the first extraction is an organic solvent-free extraction; filtering the aqueous phase to form a retentate and a permeate; drying the retentate, wherein the dried retentate comprises a first target material; filtering the permeate to form a second retentate; drying the second retentate, wherein the dried second retentate comprises a second target material.

Alternatively or additionally to any of the embodiments above, the first target material includes a protein.

Alternatively or additionally to any of the embodiments above, the second target material includes chlorogenic acid.

Alternatively or additionally to any of the embodiments above, further comprising adding a precipitating material to the permeate to form a precipitate.

Alternatively or additionally to any of the embodiments above, the precipitate includes phytic acid.

A method for extracting materials from oil seeds is disclosed. The method comprises: mixing an extraction solution to a quantity of dehulled and milled oil seeds to form a mixture; wherein the extraction solution includes water and a salt; wherein the pH of the extraction solution is 3 to 6; extracting the mixture at a temperature in the range of 10-93° C. for 0.5 to 6 hours to form an extracted mixture; filtering the extracted mixture into a retentate and a permeate; and drying the retentate.

A method for extracting materials from oil seeds is disclosed. The method comprises: mixing an extraction solution to a quantity of dehulled, pressed, and milled oil seeds to form a mixture; wherein the extraction solution includes water and a salt; wherein the pH of the extraction solution is 3 to 6; extracting the mixture at a temperature in the range of 10-93° C. for 0.5 to 6 hours to form an extracted mixture; filtering the extracted mixture into a retentate and a permeate; and drying the retentate.

A composition is disclosed. The composition comprises: a first component comprising a sunflower protein extract; and a second component comprising phytic acid.

Alternatively or additionally to any of the embodiments above, the first component comprises 91.7-99 weight-% of the composition.

Alternatively or additionally to any of the embodiments above, the second component comprises 0.28-7.7 weight-% of the composition.

Alternatively or additionally to any of the embodiments above, the second component comprises 2-6 weight-% of the composition.

Alternatively or additionally to any of the embodiments above, the composition has a sweetness that is substantially equal to a sweetness of sucrose.

Alternatively or additionally to any of the embodiments above, the composition has a sweetness that is sweeter than a sweetness of sucrose.

Alternatively or additionally to any of the embodiments above, the composition has a sweetness that is 2-10 times sweeter than a sweetness of sucrose.

Alternatively or additionally to any of the embodiments above, the composition has a sweetness that is 2-5 times sweeter than a sweetness of sucrose.

A method for extracting a plurality of target materials from oil seeds is disclosed. The method comprises: performing an extraction on an oil seed material to form an aqueous phase and a solid phase, wherein the extraction is performed in an organic solvent-free extraction; separating the insoluble solids from the aqueous phase filtering the aqueous phase to form a retentate and a permeate; drying the retentate to form a dried retentate, wherein the dried retentate comprises a first target material; filtering the permeate to form a second retentate and a second permeate; drying the second retentate to form a dried second retentate, wherein the dried second retentate comprises a second target material; filtering the second permeate to form a third retentate; drying the third retentate to form a third dried retentate, wherein the dried third retentate comprises a third target material.

Alternatively or additionally to any of the embodiments above, the first target material includes a protein.

Alternatively or additionally to any of the embodiments above, the second target material includes a second protein fraction.

Alternatively or additionally to any of the embodiments above, further comprising adding a precipitating material to the permeate to form a precipitate.

Alternatively or additionally to any of the embodiments above, the precipitate includes phytic acid.

Alternatively or additionally to any of the embodiments above, the precipitating material is calcium chloride.

Alternatively or additionally to any of the embodiments above, wherein adding a precipitating material to the permeate to form a precipitate includes adding calcium chloride at a molar ratio to phytic acid in the permeate at 5.6-6.0:1.

Alternatively or additionally to any of the embodiments above, the third target material includes chlorogenic acid.

A plant-based cheese is disclosed. The plant-based cheese comprises: a soluble sunflower protein; one or more of almond milk, coconut, potato starch, and tapioca flour; and a thickened agar solution.

Alternatively or additionally to any of the embodiments above, the plant-based cheese includes two or more of almond milk, coconut, potato starch, and tapioca flour.

Alternatively or additionally to any of the embodiments above, the plant-based cheese includes three or more of almond milk, coconut, potato starch, and tapioca flour.

Alternatively or additionally to any of the embodiments above, the plant-based cheese includes almond milk, coconut, potato starch, and tapioca flour.

Alternatively or additionally to any of the embodiments above, further comprising one or more of nutritional yeast, xanthan gum, and salt.

Alternatively or additionally to any of the embodiments above, the plant-based cheese includes two or more of nutritional yeast, xanthan gum, and salt.

Alternatively or additionally to any of the embodiments above, the plant-based cheese includes nutritional yeast, xanthan gum, and salt.

A plant-based ice cream is disclosed. The plant-based ice cream comprises: a soluble sunflower protein; an insoluble sunflower protein; one or more of pea starch, almond milk, a coconut water blend, sugar, and allulose; and a sunflower oil.

Alternatively or additionally to any of the embodiments above, the plant-based ice cream includes two or more of pea starch, almond milk, a coconut water blend, sugar, and allulose.

Alternatively or additionally to any of the embodiments above, the plant-based ice cream includes three or more of pea starch, almond milk, a coconut water blend, sugar, and allulose.

Alternatively or additionally to any of the embodiments above, the plant-based ice cream includes four or more of pea starch, almond milk, a coconut water blend, sugar, and allulose.

Alternatively or additionally to any of the embodiments above, the plant-based ice cream includes pea starch, almond milk, a coconut water blend, sugar, and allulose.

A protein-enhanced chocolate milk is disclosed. The protein-enhanced chocolate milk comprises: a soluble sunflower protein including 2-6 weight-% phytic acid; milk; and one or more of coca, calcium carbonate, and cellulose gel.

Alternatively or additionally to any of the embodiments above, the soluble sunflower protein comprising 2-6 weight-% phytic acid has a sweetness substantially equal to sucrose.

Alternatively or additionally to any of the embodiments above, the soluble sunflower protein comprising 2-6 weight-% phytic acid has a sweetness that is 2-5 times sweeter than sucrose.

A protein-enhanced sports drink is disclosed. The protein-enhanced sports drink comprises: a soluble sunflower protein including 2-6 weight-% phytic acid; water; and an electrolyte solution.

Alternatively or additionally to any of the embodiments above, the soluble sunflower protein comprising 2-6 weight-% phytic acid has a sweetness substantially equal to sucrose.

Alternatively or additionally to any of the embodiments above, the soluble sunflower protein comprising 2-6 weight-% phytic acid has a sweetness that is 2-5 times sweeter than sucrose.

Alternatively or additionally to any of the embodiments above, the protein-enhanced sports drink is free of added sugar and is free of added sugar substitutes.

Alternatively or additionally to any of the embodiments above, the protein-enhanced sports drink comprises 0.75-1.5 grams of protein per ounce.

Alternatively or additionally to any of the embodiments above, the protein-enhanced sports drink comprises substantially 1 gram of protein per ounce.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a flow chart depicting an example process.

FIG. 2 is a flow chart depicting an example process.

FIG. 3 is a flow chart depicting an example process.

FIG. 4 is a flow chart depicting an example process.

FIG. 5 is a flow chart depicting an example process.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

A number of plants produce seeds that contain extractable oils and other materials. For the purpose of this disclosure, such plants and/or more particularly the seeds of such plants may be termed oil seed plants and/or oil seeds. Example plants that produce oil seeds may include almond, argan, borage, canola, castor, cherry, coconut, corn, cotton, flax, grape, hemp, jojoba, macadamia, mango, mustard, neem, oil palm, rapeseed, safflower, sesame, shea, sunflower, tonka bean, moringa, rice (and/or rice bran), and tung. These are just examples. Extracting oil from the seeds of such plants produces vegetable oils. For example, extraction of oil from canola seeds produces canola oil.

Other than oil, a number of additional materials of interest are also present in oil seeds. Some examples of such materials include protein (e.g., soluble protein, insoluble protein, albumin, helianthinin, etc.), meal or meals (e.g., sunflower meal such as a sunflower meal with reduced oil and protein content and/or with chlorogenic acid removed, which may positively impact the color of the meal), phenolics, chlorogenic acid, phytic acid, combinations thereof, and/or the like. In some instances, extracting protein from oil seeds involves the use of organic solvents such as hexane, alcohols, and/or the like. However, such solvents may impact the environment and/or human health. In addition, such solvents may impact other materials present in oil seeds. Thus, it may be desirable to extract protein from oil seeds while having a minimal impact on the environment, improving human health, and/or allowing for other materials of interest to also be extracted. Disclosed herein are methods for processing oil seeds. These methods may be utilized to extract materials from the oil seeds. Such materials may include seed oil, protein, meal or meals, phenolics, chlorogenic acid, phytic acid, combinations thereof, and/or other materials.

This more holistic view of oil seed processing is currently lacking in the field as oil seeds are processed for their oils which often times deteriorate the other valuable nutrients in the seed. Advances in the understanding of human health and the nutrients that are required to maintain a healthy mind and body require that new technologies are developed to provide these nutrients in a sustainable way. The current disclosure allows the seeds to be processed in such a way that as many human health valuable nutrients that are available can be extracted.

Protein is one of the primary nutrients that has gained in relevance, especially plant based proteins. As the interest and desire to consume plant proteins grows, the need for new and novel sources of plant proteins grows as well. New plant protein sources that are not major allergens and/or are good tasting with functional aspects (foaming, gelling, solubility, etc.) are desirable. The present disclosure aims to provide at least some of these attributes and others.

Additionally, micronutrients such as minerals, vitamins, antioxidants, polyphenols and many others, are growing in importance as we develop the tools to understand what different individuals require in their daily nutrition. Many oil seeds contain useful micronutrients with polyphenols being the primary constituent. Sunflower seeds have two useful micronutrients in chlorogenic acid and phytic acid. Both can be extracted and isolated in a still useful nutritional form as long as harsh chemicals or extreme processing conditions (e.g., high temperatures, very low or high pH) are avoided.

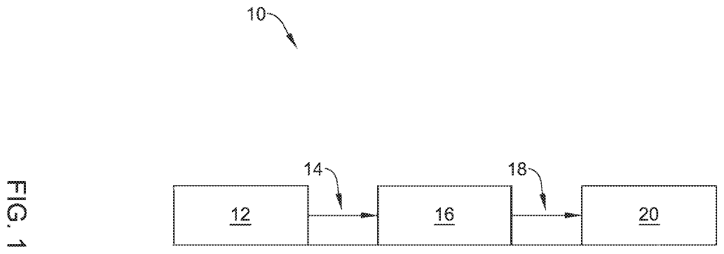

FIG. 1 is a flow chart depicting an example method, generally referred to with reference number 10, for processing oil seeds. The process may include the receipt of oil seeds 12 (e.g., raw oil seeds) from a supplier (e.g., an agricultural supplier). The raw oil seeds 12 can undergo a dehulling process 14 where, for example, the raw oil seeds 12 are brought to a processing facility and fed into a dehulling unit. When fed into the dehulling unit, the seed is cracked and the hull is separated from the seed “meat” or material 16. Upon undergoing the dehulling process, 90% or more of the hull is removed from the oil seeds, or about 99% or more of the hull is removed from the oil seeds, or about 99.9% or more of the hull is removed from the oil seeds. The hull may be discarded or moved to separated/different processing. The meat or dehulled oil seed material 16 can be further processed.

In some instances, prior to extracting the dehulled oil seed material 16, the dehulled oil seed material 16 can be pressed (e.g., cold pressed) to remove a portion of the oil from the dehulled oil seed material 16. The cold pressing process may be performed at a temperature in the range of about 70-140° F. (20-60° C.) or about 130-138° F. (54-59° C.). Pressing at such temperatures (e.g., pressing at relatively low temperatures) may help to preserve nutrients in the oil (e.g., vitamin E) as well as preserve the integrity and/or conformation of proteins in the dehulled oil seed material 16. In addition, pressing at relatively low temperature may also help to preserve the integrity of other materials of interest in the dehulled oil seed material 16 (e.g., chlorogenic acid, etc.).

The dehulled oil seed material 16 may undergo a milling process 18 to produce a milled material 20. Milling may include milling with any one (or more) of a variety of types of mills including a hammer mill, a knife mill, a colloid mill, a stone mill, and/or the like. The milling process may reduce the particle size to a D90 of less than about 3 mm, or to a D90 of about 1-2 mm or less, or the like.

In some instances, milling can result in release/liberation of oil from the de-hulled seed oil material and/or degradation of one or more components (e.g., chlorogenic acid) when temperature conditions are not controlled. In order to limit the release/liberation of oil from the de-hulled seed oil material and/or degradation of one or more components, milling may take place under temperature-controlled conditions. For example, in some instance milling is performed at a temperature of about 80-140° F. (26-60° C.), or about 120-140° F. (48-60° C.), or about 140° F. (60° C.) or less, or about 130-138° F. (54-59° C.).

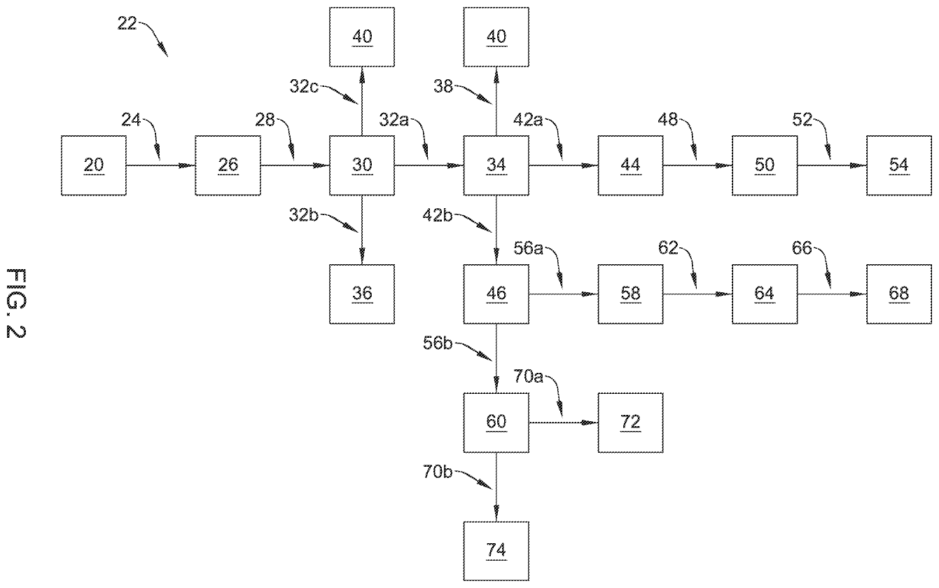

The milled material 20 may be subjected to one or more extractions. A flowchart depicting a process 22 that includes a first extraction of the milled material 20 as well as the recovery of one or more materials from the milled material 20 is shown in FIG. 2. The process 22 may include mixing the milled material 20 with an extraction solution to form a mixture 26. Mixing is generally denoted with reference number 24 in FIG. 2. In at least some instances, the extraction solution may include water and mixing the milled material 20 with the extraction solution may include adding water at a suitable ratio. For example, the milled material 20 may be mixed with water at about a 6:1 to 20:1 water to milled material 20 (e.g., the dry weight of the milled material 20) ratio or at about a 10:1 to 15:1 water to milled material 20 (e.g., the dry weight of the milled material 20) ratio. In some instances, the ratio may be about 10:1 water to milled material 20. The mixture 26 may be heated to a temperature of about 50-200° F. (10-93° C.), or about 100-140° F. (37-60° C.), or about 140° F. (60° C.), or about 130-138° F. (54-59° C.). In some instances, the pH is adjusted to a pH of about 3-6 or to a pH of about 4 using a suitable acid/base (e.g., an acid such as HCl, a base such as NaOH, and/or other suitable acids/bases). A salt may also be added to the mixture 26. In some instances, the salt may be NaCl. The salt may be added so that the mixture 26 has a salt concentration of about 0.05-2.0M NaCl, or about 0.1-1.0M NaCl, or about 0.25-0.5M NaCl, or about 0.25M NaCl. With the mixture 26 adjusted to the desired temperature and salt concentration, the mixture 26 can be held (e.g., held for the duration of the extraction) for about 0.5-6 hours or about 2 hours in a suitable vessel (e.g., such as a batch tank, a continuous stirred tank, a continuous mixed flow reactor, or the like) to extract target materials. For example, low molecular weight protein (e.g., having a molecular weight in the range of about 10-18 kDa), chlorogenic acid, and/or other target materials may be extracted into the aqueous phase. Holding the mixture in order to allow for the extraction of target materials (e.g., the first extraction) is generally denoted using reference number 28 in FIG. 2. The result of the first extraction 28 is the extracted mixture 30.

In at least some instances, the first extraction 28 may be understood to be conducted without the use of organic solvents that may impact (e.g., may degrade) other materials present in the milled material 20, impact the environment, and/or impact human health. As such, the first extraction 28 may be conducted without organic solvents or otherwise be considered to be free of organic solvents (e.g., the extraction process is performed without the use of organic solvents). In other words, the first extraction 28 may be an organic solvent-free extraction. For example, the first extraction 28 may be conducted without hexane or otherwise be considered to be free of hexane (e.g., the extraction process is performed without the use of hexane). In other words, the first extraction 28 may be a hexane-free extraction. In some of these and in other instances, the first extraction 28 may be conducted using materials that have a reduced or minimal impact on materials of interest in the milled material 20, have a reduced environmental impact, and/or a have a reduced impact on human health. For example, the first extraction 28 may be conducted using materials that have a reduced or minimal impact on chlorogenic acid in the milled material 20 (e.g., reduced or minimal likelihood for degradation of chlorogenic acid during the first extraction 28). For the purposes of this disclosure, water is not considered to be an organic solvent.

In some instances, one or more additional processes may be added to, incorporated with, and/or otherwise used in conjunction with the first extraction 28 (e.g., and/or other extractions disclosed herein). For example, 0.1-2 wt % of ascorbic acid may be added during the extraction process. This may help to reduce and/or prevent undesirable color formation that might otherwise occur due to interactions between a polyphenol oxidase, chlorogenic acid, and protein. In some of these and in other instances, adsorbent polymeric beads and/or activated carbon may be utilized to improve separation of protein from chlorogenic acid. For example, chlorogenic acid may bind to the beads and can be later eluted using a solvent such as ethanol or water, and/or by adjusting the pH. The eluted chlorogenic acid can be dried to form a powder (e.g., chlorogenic acid powder). Activated carbon can also be used during a post protein isolation step to help remove/any material that the membrane filtration did not fully remove. This may include color compounds, trace amount of chlorogenic acid, trace amount of metals, etc. The use of activated carbon may include passing a liquid protein stream over a bed of activated carbon. However, other uses/processes may be utilized.

An organic solvent-free extraction may be desirable for a number of reasons. For example, organic solvents may impact the native three-dimensional conformation of proteins present in the oil seeds. For example, extraction/treatment with such solvents can disrupt the protein conformation and/or denatures the protein. In processes where proteins are extracted for use in industries such as food industries, the disruption of the protein conformation can impact the physical properties of the protein and physical characteristics of the protein including taste. For example, sunflower protein may tend to have a relatively sweet flavor that can be perceived, for example, when sunflower seeds are consumed. Extracting protein from sunflower seeds using an organic solvent, at more extreme pHs, at higher temperatures, and/or combinations thereof may result in protein that does not retain the natural sweetness of the sunflower protein. Extractions like those disclosed herein that are performed without the use of an organic solvent, at a less extreme pH, and at a lower temperature surprisingly results in the isolation of protein material that retain their natural three-dimensional conformation and that have a surprising sweet taste.

The sweetness of sunflower protein can be utilized in product development and formulations, for example, where sweetness is desired. Compared to sucrose with a reference sweetness of 1, extracted sunflower protein provides a sweetness with an approximate sweetness of 2-10 (2-10 times sweeter than sucrose) or about 2-5 (2-5 times sweeter than sucrose). This differs from other carbohydrate sweeteners that have a sweetness closer to that of sucrose and compared to intense sweeteners (or non-nutritive sweeteners) with a sweetness up to hundreds of times that of sucrose. Thus, sunflower protein provides sweetness without the undesirable flavors and aftertaste, which may be associated with intense sweeteners. In addition, the use of such proteins may allow for the addition of sweetness without having to dilute (e.g., with bulking agents, fillers, and/or the like), allow for less sweetener (e.g., a lower quantity) to be used, allow for sweetness to be added to a product along with/simultaneously with protein, desirably impact the color effect of creaming or whitening, provide a longer profile of sweetness perception from initial sweetness to completion of flavor (e.g., without prolonged aftertaste), etc.

After the first extraction 28, the extracted mixture 30 can be separated using a separation and/or decanting process. An example of the separation/decanting of the extracted mixture 30 is denoted in FIG. 2 using reference numbers 32a, 32b, 32c. Separating/decanting the extracted mixture 30 may include transporting the mixture/slurry to a suitable solids/liquid separation unit for a separation/decanting process that separates the extracted mixture 30 into a liquid or aqueous phase 34 (e.g., reference number 32a denotes the separation/decanting of the aqueous phase 34) and a solid or wet meal 36 (e.g., reference number 32b denotes the separation of the wet meal 36). In some instances, the separation/decanting process may include the use of a decanting centrifuge.

In some instances, the wet meal 36 may be dried to form a vegetable meal or flour. Alternatively, the wet meal 36 may be further processed/extracted as discussed herein. In some of these and in other instances, the wet meal 36 may be washed one or more times, for example, to increase the yield of target materials and/or to desalt the wet meal 36. For example, water may be mixed with the wet meal and the mixture may be separated/decanted again (e.g., in a manner similar to what is disclosed herein). When doing so, the aqueous phase (e.g., which may include one or more target materials) may be added to the aqueous phase 34. In some instances, the washed wet meal may be dried to form a vegetable meal or flour. In other instances, the washed wet meal may be further processed as disclosed herein.

In addition to separating the aqueous phase 34 from the wet meal 36, the separating/decanting process may also separate seed oil 40 from the extracted mixture 30 (e.g., the aqueous phase of the extracted mixture 30) as denoted by reference number 32c. It can be appreciated that other separation/decanting processes may also be utilized including, for example, the use of one or more filters, a disk stack centrifuge, a settling chamber, combinations thereof, and/or the like. In some instances, an additional centrifugation process 38 (e.g., using a disk stack centrifuge) may be used to remove additional seed oil 40 from the aqueous phase 34. This process, however, is considered to be optional.

In some instances, the aqueous phase 34 can be mixed with a divalent ion such as calcium chloride (CaCl₂). When doing so, the calcium ions may bind with phytic acid that may be present in the aqueous phase 34, resulting in an insoluble compound that may precipitate. The resulting solid/precipitate can be separated with a suitable separation apparatus such as a centrifuge, a filter, and/or the like. The collected solid (e.g., phytic acid) can be dried, for example using a suitable process such as those disclosed herein.

Adding the divalent ion at specific amounts in relation to the starting material results in different levels of phytic acid in the final soluble protein product. As an example, when the feed to the extraction step is 33% protein, 25% oil, 2% CGA, and 3.8% phytic acid and when the divalent ion is calcium chloride, adding the calcium chloride at the levels shown in Table 1 below will result in the associated levels of phytic acid in the soluble protein product.

TABLE 1
Phytic Acid Levels at Differing CaCl₂ Amounts

| CaCl₂ added (wt % of feed) | Phytic Acid wt % in product |
|---|---|
| 3.86% | 0% |
| 3.82% | 1% |
| 3.77% | 2% |
| 3.73% | 3% |
| 3.68% | 4% |
| 3.63% | 5% |
| 3.58% | 6% |

For proteins that are extracted/isolated from sunflower seeds as disclosed herein (e.g., insoluble protein(s), high molecular weight protein(s), helianthinin(s), globulins, albumins (e.g., residual albumins), combinations thereof, and/or the like; and/or soluble proteins(s), low molecular weight protein(s), albumin(s), combinations thereof, and/or the like), the amount of phytic acid present in the protein product may be correlated with the sweetness. More particularly, the more phytic acid present in the protein, the less sweet the protein product is. For example, protein products having a phytic acid content of about 5.5-6.5% or about 6% may have a sweetness that is approximately the same as sucrose. Protein products having a phytic acid content of about 3.5-4.5% or about 4% may have a sweetness that is approximately 2 times the sweetness of sucrose. Protein products having a phytic acid content of about 1.5-2.5% or about 2% may have a sweetness that is approximately 5 times the sweetness of sucrose.

The aqueous phase 34 may be subjected to one or more filtration processes denoted in FIG. 2 using reference numbers 42a, 42b. In at least some instances, the filtration process may include an ultrafiltration process. For example, the filtration process may include using a filter membrane with a nominal pore size of about 600-8000 Daltons or about 800-2000 Daltons. When doing so, the aqueous phase 34 may be separated into a retentate or retentate stream 44 (e.g., the material that is held on or otherwise does not pass through the filter membrane) and a permeate or permeate stream 46 (e.g., the material that passes through the filter membrane). The retentate stream 44 may include protein (e.g., soluble proteins(s), low molecular weight protein(s), albumin(s), combinations thereof, and/or the like) while the permeate stream 46 may include other materials (e.g., such as chlorogenic acid, minerals, other low molecular weight compounds, and/or the like). In some instances, diafiltration water can be added to further purify the retentate stream 44. In some instances, the retentate stream 44 may be concentrated to have about 10-40% solids. 70-99% (or more) of the solids may be made up of protein, or about 80-95% of the solids may be made up of protein, or about 85-95% of the solids may be made up of protein. In some instances, the pH of the retentate stream 44 may be adjusted to a pH of about 4-7, or to a pH of about 5-6.5, or to a pH of about 5-5.5. This may include the addition of a base such as KOH, NaOH, and/or the like or an acid such as HCl, H₃PO₄, and/or the like.

The retentate stream 44 may undergo one or more drying processes. For example, the retentate stream 44 may undergo an evaporation process 48. This may include transporting/conveying the retentate stream 44 to an evaporator to concentrate the solids. The evaporator may have a liquid output that is about 20-50% solids by weight. In some instances, the evaporator may operate at a temperature of about 120-160° F. (48-72° C.) and may have a vacuum pressure of about 0.1-10 psi.

The retentate stream 44 (and/or the evaporated retentate stream, which is denoted using reference number 50) may undergo one or more further drying processes such as a drying process 52 (e.g., a spray drying process). For example, the retentate stream 44 and/or the evaporated retentate stream 50 may be transported/conveyed to a drying apparatus such as a spray dryer, a drum dryer, a flash dryer, a pan dryer, combinations thereof, and/or the like. In some instances, the drying apparatus may reduce the moisture content to about 10% or less, or about 6% or less, or about 3-6% or less. The result of the drying process 52 is a solid product 54 comprising protein (e.g., soluble protein(s), low molecular weight protein(s), albumin(s), combinations thereof, and/or the like).

In some instances, the retentate stream 44 and/or the solid product 54 can be treated with a de-colorization material (e.g., such as an activated carbon bed, adsorbents, ionic adsorbents, combinations thereof, and/or the like) to remove color compounds from the protein.

The permeate stream 46 (e.g., from the filtration process 42b) may be subjected to a further filtration process denoted in FIG. 2 with reference numbers 56a, 56b. In some instances, the filtration process may include a nanofiltration process. For example, the permeate stream 46 may be transported/conveyed to a nanofiltration membrane having a nominal pore size of about 200-800 Daltons or about 300-600 Daltons. When doing so, the nanofiltration membrane may separate the permeate stream into a second retentate or second retentate stream 58 and a second permeate or second permeate stream 60. In at least some instances, the second retentate 58 may include target materials such as chlorogenic acid. The second permeate 60 may include minerals, salt, and/or the like. In some instances, diafiltration water can be added to further purify the second retentate stream 58. The second retentate 58 may have a solid concentration of about 2-20% solids or more, or greater than about 10% solids, or greater than about 5% solids. The composition of the solids may be about 40-80% chlorogenic acid, or about 50-80% chlorogenic acid, or about 70-80% chlorogenic acid.

In some instances, the second retentate 58 may undergo one or more drying processes. For example, the second retentate 58 may undergo an evaporation process 62. This may include transporting/conveying the second retentate 58 to an evaporator to concentrate the solids. The evaporator may have a liquid output that is about 20-50% solids by weight, or about 10-20% by weight. In some instances, the evaporator may operate at a temperature of about 120-160° F. (48-72° C.) and may have a vacuum pressure of about 0.1-10 psi.

The second retentate 58 (and/or the evaporated second retentate, which is denoted using reference number 64) may undergo one or more further drying processes such as a drying process 66 (e.g., a spray drying process). For example, the second retentate 58 and/or the evaporated second retentate 64 may be transported/conveyed to a drying apparatus such as a spray dryer, a drum dryer, a flash dryer, a pan dryer, combinations thereof, and/or the like. In some instances, the drying apparatus may reduce the moisture content to about 10% or less, or about 6% or less. The result of the drying process is a solid product 68 comprising chlorogenic acid.

In some instances, the second permeate 60 can undergo a reverse osmosis process, denoted in FIG. 2 using reference numbers 70a, 70b. For example, the second permeate 60 can be sent to a reverse osmosis membrane to separate the salt 72 from the water 74. This may allow the water 74 to be re-used in one or more the processes disclosed herein, thereby reducing overall water usage. In some instances, the reverse osmosis membrane may take the form of a high salt retention membrane (e.g., greater than 95%). Like the water 74, the retained salt 72 may also be re-used in one or more of the processes disclosed herein, thereby reducing overall salt usage.

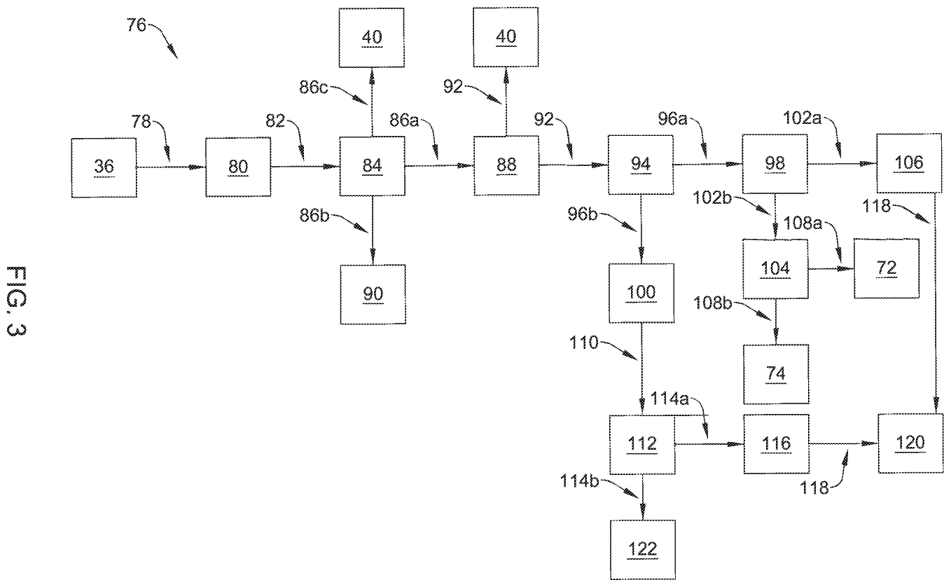

The wet meal 36 (e.g., from the separation/decanting process 32b) may be subjected to one or more additional extractions. A flowchart depicting a process 76 that includes a second extraction of the wet meal 36 as well as the recovery of one or more materials from the wet meal 36 is shown in FIG. 3. The process 76 may include mixing the wet meal 36 with an extraction solution to form a mixture 80. Mixing is generally referred to in FIG. 3 with reference number 78. In at least some instances, the extraction solution may include water and mixing the wet meal 36 with the extraction solution may include adding water at a suitable ratio. For example, the wet meal 36 may be mixed with water at about a 6:1 to 20:1 water to wet meal material (e.g., the dry weight of the wet meal material) ratio, or at about a 10:1 to 15:1 water to wet meal material (e.g., the dry weight of the wet meal material) ratio. In some instances, the ratio may be about 10:1 water to wet meal material. The mixture may be heated to a temperature of about 50-200° F. (10-93° C.), or about 100-140° F. (37-60° C.), or about 140° F. (60° C.), or about 130-138° F. (54-59° C.). In some instances, the pH is adjusted to a pH of about 5-8 or to a pH of about 5.5 using a suitable acid/base (e.g., a base such as NaOH, KOH, and/or other suitable acids/bases). A salt may also be added to the mixture 80. In some instances, the salt may be NaCl. The salt may be added so that the mixture 80 has a salt concentration of about 0.05-2.0M NaCl, or about 0.1-1.0M NaCl, or about 0.25-0.5M NaCl, or about 0.25M NaCl. With the mixture 80 adjusted to the desired temperature and salt concentration, the mixture can be held (e.g., held for the duration of the extraction) for about 0.5-6 hours or about 2 hours in a suitable vessel (e.g., such as a batch tank, a continuous stirred tank, a continuous mixed flow reactor, or the like) to extract target materials. For example, protein (e.g., insoluble protein(s), high molecular weight protein(s), helianthinin(s), globulins, albumins (e.g., residual albumins), combinations thereof, and/or the like), chlorogenic acid, and/or other target materials may be extracted into the aqueous phase. Holding the mixture in order to allow for the extraction of target materials (e.g., the second extraction) is generally denoted using reference number 82 in FIG. 3. The result of the second extraction 82 is the extracted mixture 84.

Just like the first extraction, in at least some instances, the second extraction 82 may be understood to be conducted without the use of organic solvents that may impact (e.g., may degrade) other materials present in the milled material. As such, the second extraction 82 may be conducted without organic solvents or otherwise be considered to be free of organic solvents (e.g., the extraction process is performed without the use of organic solvents). In other words, the second extraction may be an organic solvent-free extraction. For example, the second extraction 82 may be conducted without hexane or otherwise be considered to be free of hexane (e.g., the extraction process is performed without the use of hexane). In other words, the second extraction 82 may be a hexane-free extraction. In some of these and in other instances, the second extraction 82 may be conducted using materials that have a reduced or minimal impact on materials of interest in the wet meal 36, have a reduced environmental impact, and/or a have a reduced impact on human health. For example, the second extraction may be conducted using materials that have a reduced or minimal impact on chlorogenic acid in the wet meal 36 (e.g., reduced or minimal likelihood for degradation of chlorogenic acid during the second extraction 82). For the purposes of this disclosure, water is not considered to be an organic solvent.

After the second extraction 82, the extracted mixture 84 can be separated using a separation process. The separation process is denoted in FIG. 3 using reference numbers 86a, 86b, 86c. Separating the extracted mixture 84 may include transporting the mixture/slurred to a suitable solids/liquid separation unit for a separation/decanting process to separate the extracted mixture 84 into a liquid or aqueous phase 88 (e.g., the process is denoted by reference number 86a) and a solid or wet meal 90 (e.g., the process is denoted by reference number 86b; the wet meal 90 may be further processed). In some instances, the separation process may include decanting and/or the use of a decanting centrifuge. In addition to separating the aqueous phase 88 from the wet meal 90, the separating/decanting process may also separate seed oil 40 from the extracted mixture 84 as denoted by reference number 32c. It can be appreciated that other separation/decanting processes may also be utilized including, for example, the use of one or more filters, a disk stack centrifuge, a settling chamber, combinations thereof, and/or the like. In some instances, an additional centrifugation process 92 (e.g., using a disk stack centrifuge) may be used to remove additional seed oil 40 from the aqueous phase 88. This process, however, is considered to be optional.

The wet meal 90 may be washed, for example, to reduce the salt content. When doing so, water may be added at a ratio of 5:1-20:1 or about 10:1. The washed wet meal 90 can then be sent to a solid/liquid separation process and the meal may then be dried, for example to form a vegetable flour. Drying may include using a roll dryer, flash dryer, ring dryer, combinations thereof, and/or the like.

The aqueous phase 88 may be subjected to a precipitation process 92. For example, the aqueous phase 88 may have its pH adjusted to about 3-5 or to about 4-4.25 by adding a suitable acid/base (e.g., HCl). Protein present in the aqueous phase 88 may be become insoluble and precipitate. The material be mixed and transported/conveyed to a liquid/solid separation unit. The precipitated protein stream, denoted by reference number 94, can be separated into the liquid 98 (e.g., the separation process being denoted by reference number 96a) and the solid, protein precipitate 100 (e.g., the process being denoted by reference number 96b). This may include using a filter, centrifuge, combinations thereof, and/or the like. The solids 100 may be collected and further washed. The liquid 98 may undergo a further filtration process. For example, the liquid 98 may undergo a microfiltration and/or ultrafiltration process (e.g., denoted in FIG. 3 with reference numbers 102a, 102b). This may include the use of an ultrafiltration membrane having a pore size of about 10-2000 kDa or about 30-80 kDa that can separate the liquid into a permeate 104 and a retentate 106. The retentate 106 may include additional protein from the liquid that did not precipitate during the precipitation process 96a, 96b. The permeate 104 may be subjected to a reverse osmosis process (e.g., denoted by reference numbers 108a, 108b in FIG. 3). For example, the permeate 104 can be sent to a reverse osmosis membrane to separate the salt 72 from the water 74. This may allow the water 74 to be re-used in one or more the processes disclosed herein, thereby reducing overall water usage. In some instances, the reverse osmosis membrane may take the form of a high salt retention membrane (e.g., greater than 95%). Like the water 74, the retained salt 72 may also be re-used in one or more of the processes disclosed herein, thereby reducing overall salt usage.

The solids 100 from the separation process 96b may be washed using a washing process 110 to form a washed protein slurry 112. This may include the addition of water to help remove salt and other materials from the protein. In some instances, water may be added to make a 10:1 to 100:1 water to dry weight ratio, or about a 50:1 water to dry weight ratio. The pH may be adjusted to match the conditions from the precipitation state and the slurry can be subjected to a further separation process. In some instances, the washing process 110 and the separation process 96b may be combined into a single step.

The washed protein slurry 112 may be further subjected to a separation process (e.g., denoted in FIG. 3 by reference numbers 114a, 114b). The separation may separate the washed protein slurry 112 into solids 116 and liquids 122. This may include using a filter, centrifuge, combinations thereof, and/or the like. In instances where a centrifuge is used, the solids 116 may be subjected to a drying process 118. For example, the solids 116 may be may be transported/conveyed to a drying apparatus such as a spray dryer, a drum dryer, a flash dryer, a pan dryer, combinations thereof, and/or the like. The solids 106 (e.g., from the filtration process 102a) may also be subjected to the same or a similar drying process 118. In some instances, the drying process(es) may reduce the moisture content to about 10% or less, or about 6% or less. The product resulting from the drying processes 118 may be combined and form is a solid product 120 comprising protein (e.g., insoluble protein(s), high molecular weight protein(s), helianthinin(s), globulins, albumins (e.g., residual albumins), combinations thereof, and/or the like). The liquids 122 from the separation process 114b may be subjected to a reverse osmosis membrane. This may allow the water to be re-used in one or more the processes disclosed herein, thereby reducing overall water usage. In some instances, the reverse osmosis membrane may take the form of a high salt retention membrane (e.g., greater than 95%). Like the water, the retained salt may also be re-used in one or more of the processes disclosed herein, thereby reducing overall salt usage.

The extraction processes described above with reference to FIGS. 1-3 may be described as a two-extraction process. For example, the first extraction separates protein (e.g., soluble protein(s), low molecular weight protein(s), albumin(s), combinations thereof, and/or the like) and chlorogenic acid from the aqueous phase 34 and the second extraction separates protein (e.g., insoluble protein(s), high molecular weight protein(s), helianthinin(s), globulins, albumins (e.g., residual albumins), combinations thereof, and/or the like) from the wet meal 36.

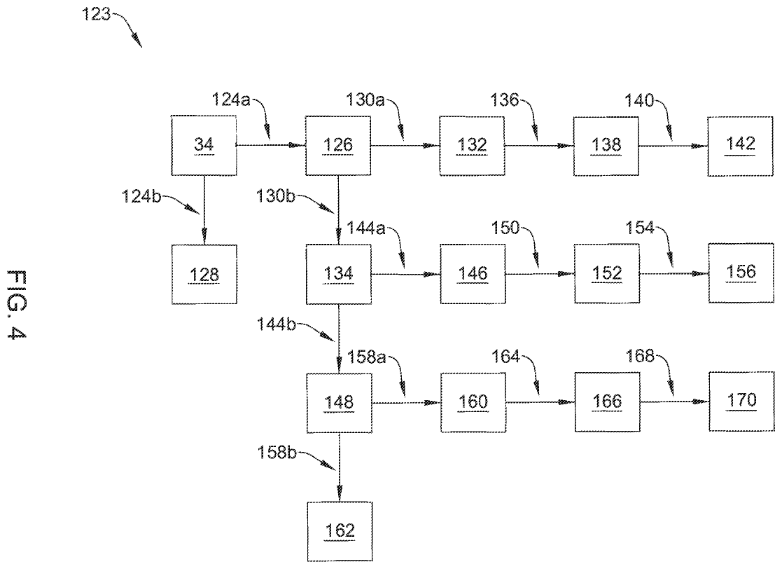

Other processes are contemplated that utilize fewer extractions or more extractions. For example, a single extraction process 123 is contemplated as depicted in FIG. 4. In such a process, a number of steps may be performed (some of which are not shown in FIG. 4) that are similar to those described above. For example, the raw oil seeds 12 can be processed as described with reference to FIG. 1 to form the milled material 20. The milled material 20 may be mixed with an extraction mixture (e.g., similar to that described above) and extracted. The extracted mixture 30 can undergo a separation/decanting process (e.g., similar to that described above) to separate the extracted mixture 30 into the aqueous phase 34 and the wet meal 36.

In some instances, the aqueous phase 34 can be mixed with a divalent ion such as calcium chloride (CaCl₂). When doing so, the calcium ions may bind with phytic acid that may be present in the aqueous phase 34, resulting in an insoluble compound that may precipitate. The resulting solid/precipitate can be separated with a suitable separation apparatus such as a centrifuge, a filter, and/or the like. The collected solid (e.g., phytic acid) can be dried, for example using a suitable process such as those disclosed herein.

In the single extraction process 123, the aqueous phase 34 can undergo a series of filtration processes, which may be similar to those disclosed herein, in order to isolate materials of interest. For example, a first filtration process (denoted by reference numbers 124a, 124b) may filter the aqueous phase (forming a permeate or filtered aqueous phase 126) and may remove insoluble particles and/or oil 128 (e.g., which may be recovered as a processed meal) from the aqueous phase 34. The first filtration process may be considered to be a microfiltration process using a filter with a pore size in the range of about 0.05-2 microns, or about 0.2 microns. In some instances, the filter may be a cross flow filtration unit, a dead end filter, and/or the like. When using a cross flow filtration unit, diafiltration can be used to increase recovery of the target materials in the filtered aqueous phase 126.

The filtered aqueous phase 126 may undergo another filtration process (denoted by reference numbers 130a, 130b) to separate the filtered aqueous phase 126 into a retentate 132 and a permeate 134. The filtration process 130a, 130b may take the form of an ultrafiltration process. The retentate 132 can be processed by an evaporation process 136 to form an evaporated retentate 138 and/or undergo a drying process 140 to form a dried material 142. The dried material 142 may comprise protein (e.g., insoluble protein(s), high molecular weight protein(s), helianthinin(s), globulins, albumins (e.g., residual albumins), combinations thereof, and/or the like).

The permeate 134 may undergo another filtration process (denoted by reference numbers 144a, 144b) to separate the permeate 134 into a retentate 146 and a permeate 148. The filtration process 144a, 144b may take the form of an ultrafiltration and/or nanofiltration process. The retentate 146 can be processed by an evaporation process 150 to form an evaporated retentate 152 and/or undergo a drying process 154 to form a dried material 156. The dried material 156 may comprise protein (e.g., soluble protein(s), low molecular weight protein(s), albumin(s), combinations thereof, and/or the like).

The permeate 148 may undergo another filtration process (denoted by reference numbers 158a, 158b) to separate the permeate 148 into a retentate 160 and a permeate 162. The filtration process 158a, 158b may take the form of a nanofiltration process. The retentate 160 can be processed by an evaporation process 164 to form an evaporated retentate 166 and/or undergo a drying process 168 to form a dried material 170. The dried material 170 may comprise chlorogenic acid.

It can be appreciated that the various processes that make up the single extraction process 123 may make use of processes disclosed herein such as oil removal, centrifugation, diafiltration, reverse osmosis to recover water and/or salt, and/or the like.

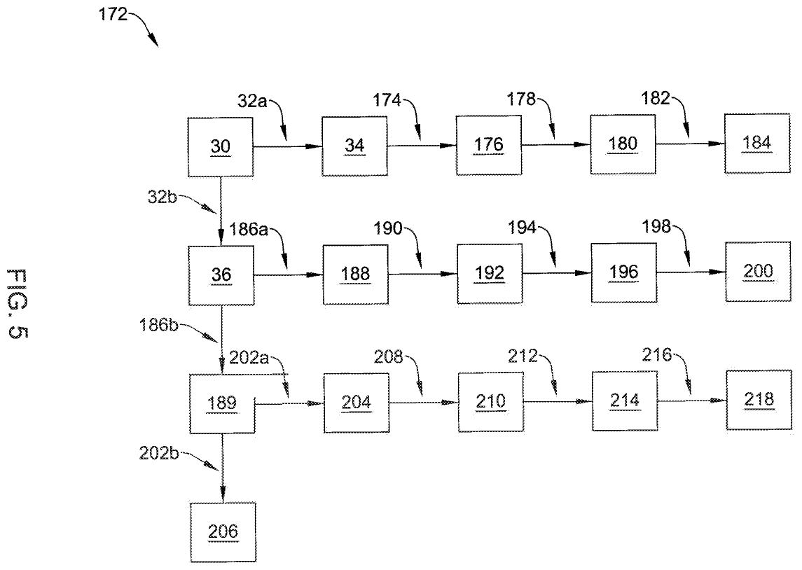

Also contemplated is a three extraction process 172 as depicted in FIG. 5. For example, the raw oil seeds 12 can be processed as described with reference to FIG. 1 to form the milled material 20. The milled material 20 may be mixed with an extraction mixture (e.g., similar to that described above) and extracted. The extracted mixture 30 can undergo a separation/decanting process (e.g., similar to that described above) to separate the extracted mixture 30 into the aqueous phase 34 (e.g., as depicted by reference number 32a) and the wet meal 36 (e.g., as depicted by reference number 32a).

In some instances, the aqueous phase 34 can undergo a centrifugation step as described above, which may help to remove oil from the aqueous phase 34.

In some instances, the aqueous phase 34 can be mixed with a divalent ion such as calcium chloride (CaCl₂). When doing so, the calcium ions may bind with phytic acid that may be present in the aqueous phase 34, resulting in an insoluble compound that may precipitate. The resulting solid/precipitate can be separated with a suitable separation apparatus such as a centrifuge, a filter, and/or the like. The collected solid (e.g., phytic acid) can be dried, for example using a suitable process such as those disclosed herein.

The aqueous phase 34 may undergo a filtration process 174. In some instances, the filtration process 174 may be a nanofiltration process and/or an ultrafiltration process. For example, the aqueous phase 34 may be transported/conveyed to a nanofiltration member having a nominal pore size of about 200-800 Daltons or about 300-600 Daltons. When doing so, the nanofiltration membrane may separate a retentate 176 from the aqueous phase 34. In at least some instances, the retentate 176 may include target materials such as chlorogenic acid. The retentate 176 may have a solid concentration of about 2-20% solids or more, or greater than about 10% solids, or greater than about 5% solids. The composition of the solids may be about 40-80% chlorogenic acid, or about 50-80% chlorogenic acid, or about 70-80% chlorogenic acid.

In some instances, the retentate 176 may undergo one or more drying processes. For example, the retentate 176 may undergo an evaporation process 178. This may include transporting/conveying the retentate 176 to an evaporator to concentrate the solids. The evaporator may have a liquid output that is about 20-50% solids by weight, or about 10-20% by weight. In some instances, the evaporator may operate at a temperature of about 120-160° F. (48-72° C.) and may have a vacuum pressure of about 0.1-10 psi.

The retentate 176 (and/or the evaporated retentate, which is denoted using reference number 180) may undergo one or more further drying processes such as a drying process 182 (e.g., a spray drying process). For example, the retentate 176 and/or the evaporated retentate 180 may be transported/conveyed to a drying apparatus such as a spray dryer, a drum dryer, a flash dryer, a pan dryer, combinations thereof, and/or the like. In some instances, the drying apparatus may reduce the moisture content to about 10% or less, or about 6% or less. The result of the drying process is a solid product 184 comprising chlorogenic acid.

The wet meal 36 can undergo a second extraction process. The second extraction process may be similar to other extraction processes disclosed herein. For example, the wet meal 36 may be mixed with water at about a 6:1 to 20:1 water to wet meal material (e.g., the dry weight of the wet meal material) ratio, or at about a 10:1 to 15:1 water to wet meal material (e.g., the dry weight of the wet meal material) ratio. In some instances, the ratio may be about 10:1 water to wet meal material. The mixture may be heated to a temperature of about 50-200° F. (10-93° C.), or about 100-140° F. (37-60° C.), or about 140° F. (60° C.), or about 130-138° F. (54-59° C.). In some instances, the pH is adjusted to a pH of about 2-8, or to a pH of about 3-6, or to a pH of about 4.0 using a suitable acid/base (e.g., an acid such as HCl, a base such as NaOH or KOH, and/or other suitable acids/bases). A salt may also be added to the mixture. In some instances, the salt may be NaCl. The salt may be added so that the mixture has a salt concentration of about 0.05-2.0M NaCl, or about 0.1-1.0M NaCl, or about 0.25-0.5M NaCl, or about 0.25M NaCl. With the mixture adjusted to the desired temperature and salt concentration, the mixture can be held (e.g., held for the duration of the extraction) for about 0.5-6 hours or about 2 hours in a suitable vessel (e.g., such as a batch tank, a continuous stirred tank, a continuous mixed flow reactor, or the like) to extract target materials. For example, protein (e.g., soluble protein(s), low molecular weight protein(s), albumin(s), combinations thereof, and/or the like) and/or other target materials may be extracted into the aqueous phase.

The extracted wet meal 36 can undergo a separation/decanting process (e.g., similar to that described above) to separate the extracted wet meal 36 into the aqueous phase 188 (e.g., as depicted by reference number 186a) and the second wet meal 189 (e.g., as depicted by reference number 186a).

A filtration process 190 may filter the aqueous phase 188 to form a retentate 192. The filtration process 190 may be considered to be a nanofiltration process using a filter with a pore size in the range of about 200-800 Daltons or about 300-600 Daltons.

The retentate 192 be processed by an evaporation process 194 to form an evaporated retentate 196 and/or undergo a drying process 198 to form a dried material 200. The dried material 200 may comprise protein (e.g., soluble protein(s), low molecular weight protein(s), albumin(s), combinations thereof, and/or the like).

The second wet meal 189 may undergo a third extraction similar to what is described above. For example, the second wet meal 189 may be mixed with water at about a 6:1 to 20:1 water to wet meal material (e.g., the dry weight of the wet meal material) ratio, or at about a 10:1 to 15:1 water to wet meal material (e.g., the dry weight of the wet meal material) ratio. In some instances, the ratio may be about 10:1 water to wet meal material. The mixture may be heated to a temperature of about 50-200° F. (10-93° C.), or about 100-140° F. (37-60° C.), or about 140° F. (60° C.), or about 130-138° F. (54-59° C.). In some instances, the pH is adjusted to a pH of about 5-8 or to a pH of about 5.5 using a suitable acid/base (e.g., an acid such as HCl, a base such as NaOH or KOH, and/or other suitable acids/bases). A salt may also be added to the mixture. In some instances, the salt may be NaCl. The salt may be added so that the mixture has a salt concentration of about 0.05-2.0M NaCl, or about 0.1-1.0M NaCl, or about 0.25-0.5M NaCl, or about 0.25M NaCl. With the mixture adjusted to the desired temperature and salt concentration, the mixture can be held (e.g., held for the duration of the extraction) for about 0.5-6 hours or about 2 hours in a suitable vessel (e.g., such as a batch tank, a continuous stirred tank, a continuous mixed flow reactor, or the like) to extract target materials. For example, protein (e.g., insoluble protein(s), high molecular weight protein(s), helianthinin(s), globulins, albumins (e.g., residual albumins), combinations thereof, and/or the like), chlorogenic acid, and/or other target materials may be extracted into the aqueous phase.

The extracted second wet meal 189 can undergo a separation/decanting process (e.g., similar to that described above) to separate the extracted second wet meal 189 into the aqueous phase 204 (e.g., as depicted by reference number 202a) and the third wet meal 206 (e.g., as depicted by reference number 202b). The third wet meal may be dried to form a vegetable meal or flour.

A filtration process 208 may filter the aqueous phase 204 to form a retentate 210. The filtration process 208 may be considered to be an ultrafiltration process using a filter with a pore size in the range of about 10-2000 kDa or about 30-80 kDa. When using a cross flow filtration unit, diafiltration can be used to increase recovery of the target materials in the retentate 210.

The retentate 210 be processed by an evaporation process 212 to form an evaporated retentate 214 and/or undergo a drying process 216 to form a dried material 218. The dried material 218 may comprise protein (e.g., insoluble protein(s), high molecular weight protein(s), helianthinin(s), globulins, albumins (e.g., residual albumins), combinations thereof, and/or the like).

In some instances, the permeate of the filtration process 208 can be sent to an adsorption column filled with adsorbent beads, for example adsorbent beads that selectively adsorbs chlorogenic acid, and allows most other materials to pass through. The chlorogenic acid can then be eluted from the column using a pH swing or another solvent such as ethanol. Other permeates disclosed herein can be similarly processed such as a permeate passing through a microfiltration membrane/filter, a permeate passing through an ultrafiltration membrane/filter, etc.

A number of applications for using the substances extracted/isolated as disclosed herein and/or the processes as disclosed herein are contemplated. Some of the contemplated applications include the use of the extracted isolated substances in food products.

One example application is a plant-based cheese. The plant-based cheese may include a soluble sunflower protein (e.g., soluble proteins(s), low molecular weight protein(s), albumin(s), combinations thereof, and/or the like) isolated/extracted from sunflower seeds using the processes disclosed herein. The soluble sunflower protein (e.g., about 0.5-5%, or about 1-3%, or about 2.0%) may be combined (e.g., using a blender or other suitable mixing device) with other materials such as one or more of almond milk (e.g., about 20-40%, or about 25-35%, or about 31.8%), coconut oil (e.g., about 2-10%, or about 4-6%, or about 5.2%), potato starch (e.g., about 2-10%, or about 4-6%, or about 5.2%), tapioca flour (e.g., 2-10%, or about 3-5%, or about 4.0%), nutritional yeast (e.g., about 1-3%, or about 1.5-1.8%, or about 1.6%), xanthan gum (e.g., about 0.01-1%, or about 0.05-0.15%, or about 0.1%), and salt (e.g., about 0.1-2%, or about 0.5-1.5%, or about 0.6%). The percentages given are percentages by weight relative to all starting materials. The combination (e.g., the almond milk mixture) may be mixed/blended until it has desired creamy consistency.

Separately, an agar solution may be formed by combining water (e.g., about 30-60%, or about 40-50%, or about 45.7%) with agar (e.g., about 2-6%, or about 3-4.5%, or about 3.9%) and heating until the agar is dissolved. The agar solution may be further cooked (e.g., covered using low heat) until thickened.

The almond milk mixture may be combined with the thickened agar solution. This may include adding a portion (e.g., about half) of the almond milk mixture to the thickened agar solution while mixing and then adding the remainder of the almond milk mixture. This can be done under low heat until the mixture detaches from the sides of the heating vessel, thereby forming the plant-based cheese. The plant-based cheese can be cooled (e.g., placed a suitable container and refrigerated).

Another example application is a plant-based ice cream. The plant-based ice cream may include a soluble sunflower protein (e.g., soluble proteins(s), low molecular weight protein(s), albumin(s), combinations thereof, and/or the like) isolated/extracted from sunflower seeds using the processes disclosed herein and an insoluble sunflower protein (e.g., insoluble protein(s), high molecular weight protein(s), helianthinin(s), globulins, albumins (e.g., residual albumins), combinations thereof, and/or the like) isolated/extracted from sunflower seeds using the processes disclosed herein. The insoluble sunflower protein (e.g., about 1-8%, or about 2-6%, or about 4%) and the soluble sunflower protein (e.g., about 0.5-5%, or about 1-3%, or about 2%) may be combined with a stabilizer (e.g., such as GRINDSTED stabilizer blend; about 0.1-1%, or about 0.2-0.6%, or about 0.4%), pea starch (e.g., about 0.1-3%, or about 0.5-1.5%, or about 1%) with strong agitation until fully incorporated. Other components such as almond milk (e.g., about 10-50%, or about 20-40%, or about 30%), a coconut water blend (e.g., about 5-30%, or about 10-20%, or about 14%), sugar (e.g., about 1-10%, or about 4-8%, or about 6%), and allulose (1-30%, or about 5-15%, or about 10%) may be added and mixed thoroughly. Sunflower oil (e.g., about 1-30%, or about 5-15%, or about 10%) may be added and agitated with a strong impeller type agitator/mixer to form an emulsion. The emulsion was heated on slow heat while stirring to 163 degrees F. (73 degrees C.). The emulsion was then cooled rapidly with agitation using an ice bath to a temperature less than 70 degrees F.

The cooled mixture was then placed in a personal or commercial ice cream machine (e.g., following manufacturer guidelines) to form the ice cream.

Another example application is a protein-enhanced chocolate milk. The protein-enhanced chocolate milk may include a soluble sunflower protein (e.g., soluble proteins(s), low molecular weight protein(s), albumin(s), combinations thereof, and/or the like) isolated/extracted from sunflower seeds using the processes disclosed herein. The soluble sunflower protein may be combined with milk, coca (e.g., about 0.5-5%, or about 1-3%, or about 1.5%), calcium carbonate (e.g., about 0.1-2%, or about 0.2-0.8%, or about 0.5%), cellulose gel (e.g., about 0.05-1%, or about 0.1-0.5%, or about 0.3%), natural and artificial flavoring (e.g., about 0.05-1%, or about 0.1-0.5%, or about 0.2%), salt (e.g., about 0.05-1%, or about 0.1-0.5%, or about 0.15%), carrageenan (e.g., about 0.01-0.5%, or about 0.08-0.12%, or about 0.1%), and cellulose gum (e.g., about 0.01-0.5%, or about 0.08-0.12%, or about 0.1%).

In some instances, the amount of phytic acid in the soluble sunflower protein may be controlled to modulate the sweetness of the protein-enhanced chocolate milk. For example, the soluble sunflower protein may have a phytic acid content of about 1-8 weight-%, or about 2-6 weight-%. In some instances, the soluble sunflower protein (e.g., about 1-10%, or about 4-5%, or about 4.4%) having a sweetness approximately equal to sucrose and containing 6 wt % phytic acid may be combined with milk (e.g., 1% milk; about 80-96%, or about 90-95%, or about 92.75%) and the remaining ingredients listed above. In some instances, the soluble sunflower protein (e.g., about 0.5-5%, or about 1-3%, or about 2.17%) having a sweetness approximately 2 times the sweetness of sucrose and containing 4 wt % phytic acid may be combined with milk (e.g., 1% milk; about 85-98%, or about 94-96%, or about 94.98%) and the remaining ingredients listed above. In some instances, the soluble sunflower protein (e.g., about 0.1-2%, or about 0.5-1.5%, or about 0.8%) having a sweetness approximately 5 times the sweetness of sucrose and containing 2 wt % phytic acid may be combined with milk (e.g., 1% milk; about 85-99%, or about 94-97%, or about 96.35%) and the remaining ingredients listed above. These are just examples. Other compositions are contemplated.

Another example application is a protein-enhanced sports drink. The protein-enhanced sports drink may include a soluble sunflower protein (e.g., soluble proteins(s), low molecular weight protein(s), albumin(s), combinations thereof, and/or the like) isolated/extracted from sunflower seeds using the processes disclosed herein. The soluble sunflower protein may be combined with water, electrolytes (e.g., an electrolyte solution and/or suitable salts), and other substances (e.g., such as natural and/or artificial flavors, natural and/or artificial colors, sugars and/or sugar substitutes, and/or the like).

In some instances, the amount of phytic acid in the soluble sunflower protein may be controlled to modulate the sweetness of the protein-enhanced sports drink. In some instances, this may allow for less sugar and/or sugar substitutes to be added to the protein-enhanced sports drink. In some of these and in other instances, the sweetness of the soluble sunflower protein may allow for substantially no sugar or sugar substitutes to be added to the protein-enhanced sports drink. For example, the soluble sunflower protein may have a phytic acid content of about 1-8 weight-%, or about 2-6 weight-%. In some instances, the soluble sunflower protein having a sweetness approximately equal to sucrose and containing 6 wt % phytic acid may be combined with water, electrolytes, and other desirable ingredients. In some instances, the soluble sunflower protein having a sweetness approximately 2 times the sweetness of sucrose and containing 4 wt % phytic acid may be combined with water, electrolytes, and other desirable ingredients. In some instances, the soluble sunflower protein having a sweetness approximately 5 times the sweetness of sucrose and containing 2 wt % phytic acid may be combined with water, electrolytes, and other desirable ingredients. These are just examples. Other compositions are contemplated.

The resultant protein-enhanced sports drinks may have a desirable clarity (e.g., free from or having a generally reduced level of cloudiness). In addition, the use of the soluble sunflower protein may allow for a higher level of protein per ounce. For example, the resultant protein-enhanced sports drinks may have about 0.75-1.5 grams of protein per ounce of sports drink, or about 1 gram of protein per ounce of sports drink.

### EXAMPLES

The disclosure may be further clarified by reference to the following Examples, some of which are prophetic in nature, and serve to exemplify some embodiments, and not to limit the disclosure in any way.

### Example 1—Extraction of Albumin, Chlorogenic Acid (CGA), Phytic Acid, and Helianthin from Sunflower Seeds

Sunflower seeds were obtained from a commercial source. The sunflower seeds were dehulled, cold-pressed and milled. The milled material underwent an extraction process substantially as disclosed herein with reference to FIG. 4. In doing so, albumin, chlorogenic acid, phytic acid and helianthinin were isolated from the sunflower seeds.

The milled seeds were mixed with water at a 10:1 water to dry weight ratio, with NaCl added to make a 0.5M NaCl solution, heated to 138F and mixed for 2 hours. After 2 hours, the slurry was separated using a decanting centrifuge. The solids stream was mixed with water at 10:1 water to dry weight ratio and decanted again with the liquid stream from the first and second decanter combined. The solids stream was dried to form a sunflower meal. The liquid stream was mixed with CaCl₂) at 2.5 wt % of the meal in the initial extraction slurry. The pH was then raised to 5.8 with NaOH and then sent to a three phase disk stack centrifuge where an oil/oil:water emulsion was recovered as the light stream, a protein (albumins and helianthinin) and CGA containing aqueous stream was recovered and a wet solids stream was discharged. The aqueous stream was sent to a 0.2-micron microfiltration membrane and diafiltration water was added after concentrating the stream to a factor of four. Diafiltration water was added at 0.25 times the volume of the initial volume of the stream sent to the membrane. The retentate was composed of large particles (primarily sunflower meal and the oil that did not get separated in the disk stack centrifuge) while the clarified permeate contained the proteins and the CGA. The permeate was subsequently sent to a 30 kDa ultrafiltration membrane. The retentate was concentrated to a factor of 5 of the starting volume and diafiltration water was added at 0.5 times the volume of the material sent to the ultrafiltration membrane. The retentate contained the helianthinin and the permeate contained the albumins and the CGA. The retentate was sent to an evaporator to concentrate the solids to 15% before going to a flash dryer to create a dry, insoluble sunflower protein powder that is 90 wt % protein. The permeate was sent to a 1 kDa ultrafiltration membrane. The retentate was concentrated to a factor of 10 of the starting volume and diafiltration water was added at 0.5 times the volume of the material sent to the membrane. The retentate contained the albumins and the permeate contained the CGA. The retentate was sent to an evaporator to concentrate the solids to 40 wt % before going to a spray dryer to create a dry, soluble sunflower protein that was 90 wt % protein. The permeate was sent to a 300 Da nanofiltration membrane and concentrated to a factor of 20. Diafiltration water was added at 0.25 times the volume of the material sent to the membrane. The permeate primarily contained NaCl and the retentate comprised the CGA. The CGA heavy retentate was sent to an evaporator to concentrate to 10% solids before going to a spray dryer where a dry, CGA powder as produced that is 60 wt % CGA.

### Example 2—Extraction of Albumin, Chlorogenic Acid (CGA), Phytic Acid, and Helianthin from Sunflower Seeds

Sunflower seeds were obtained from a commercial source. The sunflower seeds were dehulled, cold-pressed and milled. The milled material underwent an extraction process substantially as disclosed herein with reference to FIGS. 1-3. In doing so, albumin, chlorogenic acid, phytic acid and helianthin were isolated from the sunflower seeds.

The milled and pressed seeds were mixed with water at a 10:1 water to dry weight ratio, with NaCl added to make a 0.5M NaCl solution, pH brought to and maintained at a pH of 4.0, heated to 138F and mixed for 2 hours. After 2 hours, the slurry was separated using a decanting centrifuge. The solids stream was mixed with water at 10:1 water to dry weight ratio and decanted again with the liquid stream from the first and second decanter combined. The solids stream was retained for further extraction. The liquid stream from both decanters was sent to a 3 phase clarifying disk stack centrifuge to remove residual oil and residual insoluble solids. The clarified stream was sent to a 0.1 micron microfiltration membrane to remove any residual oil and insoluble species. The permeate was mixed with calcium chloride and sent to a disk stack centrifuge to remove the precipitated phytic acid. The collected solids were dried in a fluid bed dryer to form a dry calcium phytate powder. The liquid stream from the disk stack centrifuge was then sent to a 1 kDa ultrafiltration membrane and diafiltration water was added at a rate of 0.5 times the volume of the material sent to the membrane to pass the chlorogenic acid through to the permeate. The retentate contained the albumins and the permeate contained the CGA. The retentate was sent to an evaporator to concentrate the solids to 40 wt % before going to a spray dryer to create a dry, soluble sunflower protein that is 90 wt % protein. The permeate was sent to a 300 Da nanofiltration membrane and concentrated to a factor of 20. Diafiltration water was added at 0.25 times the volume of the material sent to the membrane. The permeate primarily contained NaCl and the retentate comprised the CGA. The CGA heavy retentate was sent to an evaporator to concentrate to 10% solids before going to a spray dryer where a dry, CGA powder was produced at 60 wt % CGA.

The retained solids stream from the second decanter was mixed with water at a 15:1 ratio, with NaCl added to make a 0.5M NaCl solution, pH brought to and maintained at a pH of 5.8, heated to 138F and mixed for 2 hours. After 2 hours, the slurry was separated using a decanting centrifuge. The solids stream was mixed with water at 10:1 water to dry weight ratio and decanted again with the liquid stream from the first and second decanter combined. The solids stream was dried to form a sunflower meal. The combined liquid stream was passed through a 0.1 micron microfiltration membrane to remove any fats/oils and insoluble species. The permeate was mixed with hydrochloric acid to bring the pH to 4.0 and the precipitate was collected using a decanting centrifuge. The solids stream was retained. The liquid stream was sent to a 30 kDa ultrafiltration membrane to retain the remaining protein and pass the salt through to the permeate. Diafiltration water was added at 0.5 times the volume of the feed. The retentate was sent to an evaporator to concentrate the solids to 15%, subsequently mixed with the retained solids from the precipitation step before going to a flash dryer to create a dry, insoluble sunflower protein powder that was 90 wt % protein.

### Example 3—Emulsification

The soluble protein was isolated/extracted from sunflower seeds using the processes disclosed herein. The protein may be used as an emulsifier. For example, the protein can be mixed with a number of different oils to form vegetable-based mayonnaise, creamy dressings, non-dairy milks, and/or the like. For example, six grams of protein isolated from sunflower seeds using the processes disclosed herein were mixed with 14 g of water. The mixture was added to a food processor. The food processor was turned on and one-half cup of canola oil was slowed added to the mixture over approximately 2 minutes. After all of the oil was added, the resultant mixture, which may take the form of a mayonnaise, was processed for another 30 seconds.

### Example 4—Foam Stability

Soluble protein was isolated/extracted from sunflower seeds using the processes disclosed herein. The ability of the protein to be used to form a stable foam was tested. The foam stability tests were at three pH levels: pH4, natural pH (5.5), and pH 7. To test foam stability, 20 mL of 0.5% solids solution of the soluble protein was put into a 400 mL beaker. The 0.5% solids solution included soluble protein that was isolated/extracted from sunflower seeds using the processes disclosed herein. The liquid was whipped for 1 min with a Bodum Schiuma handheld Milk Frother. The foam was then transferred to a 250 mL graduated cylinder. The initial foam volume was recorded. The volume of the foam was recorded every minute for 10 minutes. The foam stability tests were performed at room temperature (21° C.).

A first trial was conducted to determine the foam stability of the soluble protein. The first trial demonstrated that the soluble protein was able to maintain a stable foam over an extended period of time. In particular, at a pH of 4 and at a pH of 5.5, the soluble protein was able to maintain 72% and 76%, respectively, of the original foam volume after 10 minutes. The results of this foam stability test are shown in Table 2.

TABLE 2
Results of Foam Stability Testing, Trial 1.

| | mL foam | mL foam | mL foam |
|---|---|---|---|
| time | at pH 4 | at pH 5.5 | at pH 7 |
| 0 | 75 | 82 | 80 |
| 1 | 73 | 78.5 | 77 |
| 2 | 70 | 76 | 75 |
| 3 | 66 | 73 | 65 |
| 4 | 61 | 71 | 47 |
| 5 | 58.5 | 69 | 43 |
| 6 | 57.5 | 68 | 22 |
| 7 | 57 | 66 | 13 |
| 8 | 55 | 65 | 12 |
| 9 | 54.5 | 63 | 11 |
| 10 | 54 | 62.5 | 10.5 |

A second trial was conducted to determine the foam stability of the soluble protein. The second trial also demonstrated that the soluble protein was able to maintain a stable foam over an extended period of time. In particular, at a pH of 4, the soluble protein was able to maintain 56% of the original foam volume after 10 minutes. The results of this foam stability test are shown in Table 3.

TABLE 3
Results of Foam Stability Testing, Trial 2.

| | mL foam | mL foam | mL foam |
|---|---|---|---|
| time | at pH 4 | at pH 5.5 | at pH 7 |
| 0 | 77 | 80 | 95 |
| 1 | 73 | 12 | 84 |
| 2 | 65 | 6 | 80 |
| 3 | 63 | 5 | 51.5 |
| 4 | 61 | 4 | 36 |
| 5 | 60 | 3.5 | 20.5 |
| 6 | 54 | 3.5 | 9 |
| 7 | 52.5 | 3 | 7 |
| 8 | 45 | 3 | 5 |
| 9 | 43.5 | 3 | 5 |
| 10 | 43 | 3 | 5 |

### Example 5—Ready-to-Mix Beverage

The soluble protein was isolated/extracted from sunflower seeds using the processes disclosed herein. A powdered mix was formed by combining the isolated protein (78.3%), cocoa powder (11.6%), sugar (5.8%), xantham gum (2.0%), salt (1.2%), vanilla extract (0.9%), and monk fruit extract (0.2%). 35 g of the powdered mix was mixed/blended with 12 ounces of water to form a beverage.

### Example 6—High Protein Cracker

The soluble protein was isolated/extracted from sunflower seeds using the processes disclosed herein. A mixture was formed by combining the soluble protein (12.2%), flour (49.3%), unsalted butter (20.10%), water (15.8%), and baking soda (2.5). More particularly, the flour, soluble protein, and baking soda were mixed until well combined and then cold butter was worked into the mixture until well combined. Water (room temperature) was added and the dough was needed until smooth. The dough was shaped into a desired shape (e.g., a rectangle), wrapped in plastic, and allowed to rest for 30 minutes. The shaped dough was rolled out to a thickness of about 1/16 of an inch and then baked for about 7 minutes. In some cases, the rolled dough was lightly brushed with olive oil and sprinkled with sea salt prior to baking.

### Example 7—High Protein Chocolate Chip Cookies

The soluble protein was isolated/extracted from sunflower seeds using the processes disclosed herein. A mixture was formed by combining the soluble protein (13.29%), flour (27.79%), semi-sweet chocolate chips (18.92%), eggs (11.98%), unsalted butter (11.19%), sugar (8.13%), light brown sugar (8.13%), vanilla extract (0.21%), baking soda (0.21%), and salt (0.15%). More particularly, the sugars, butter, vanilla and egg were mixed together then the flour, soluble protein, baking soda, and salt were added to form a dough. The chocolate chips were added. The dough was formed into balls and baked about 8-9 at 350° F.

### Example 8—Chocolate Peanut Butter Protein Bar

The soluble protein was isolated/extracted from sunflower seeds using the processes disclosed herein. A mixture was formed by combining the soluble protein (22.6%), quick oats (15.13%), almonds (15.13%), peanut butter (12.10%), chocolate chips (10.92%), dates (9.43%), maple syrup (5.26%), water (4.52%), cocoa powder (3.77%), vanilla extract (0.66%), and salt (0.53%). More particularly, the dates, quick oats, and almonds were processed using a food processor until the dates were in pea-sized pieces. The soluble protein and cocoa powder were added and the mixture was further processed. The chocolate chips were melted and added to the mixture along with the remaining ingredients. The mixture was processed until well combined. The processed mixture was placed between two sheets of parchment paper and rolled out to a thickness of about ½ inches. A knife was then used to cut the material into bars.

### Example 9—Foods/Beverages with Soluble Proteins

The soluble protein was isolated/extracted from sunflower seeds using the processes disclosed herein. The protein can be used to form a number of different beverages including plant-based milks, protein beverages, nutrition/protein bars, confectionary, and/or the like.

### Example 10—Other Applications

The protein isolated/extracted from sunflower seeds using the processes disclosed herein may be used as an emulsifier (e.g., a food ingredient that helps to form and stabilize an emulsion). An emulsion is a mixture of oil in water or water in oil, that is stable and provides texture and flavor to a food system. Food products that may utilize such isolated/extracted sunflower protein may include mayonnaise, creamy dressings, non-dairy milks, and beverage where fat/oil is a component, etc.

The protein isolated/extracted from sunflower seeds using the processes disclosed herein may be used as a foam stabilizer. A foam is a stable air in liquid mixture in which the protein help form and stabilize the structure. Food products that may utilize such isolated/extracted sunflower protein may include meringue, whipped toppings, dairy foams (such as on a cappuccino coffee, mousse, dairy desserts) ice cream (e.g., which has element of a foam structure), etc.

The protein isolated/extracted from sunflower seeds using the processes disclosed herein may be used as a gelling agent. A protein gel is formed when the proteins cross link and stabilize a solution creating viscosity, including to a solid form. Food products that may utilize such isolated/extracted sunflower protein include salad dressings, gelatin snacks, etc.

The protein isolated/extracted from sunflower seeds using the processes disclosed herein may be used as a viscosity agent. The protein forms cross links and interacts with other food components to create viscosity. Food products that may utilize such isolated/extracted sunflower protein include beverages, sauces, dairy analogues, flavor enhancers, an enhancer that impacts mouthfeel, etc.

The protein isolated/extracted from sunflower seeds using the processes disclosed herein may be used as a flavor enhancer.

The protein isolated/extracted from sunflower seeds using the processes disclosed herein may be used as a soluble protein product that may impact the taste, texture, and appearance of the resultant food product and/or beverage. Food products that may utilize such isolated/extracted sunflower protein include plant-based milks, protein beverages (e.g., ready to drink), nutrition bars, protein confectionaries, etc.

The protein isolated/extracted from sunflower seeds using the processes disclosed herein may be used for its water holding capacity. Water holding capacity is the ability of food to hold its own or added water during the application of force, pressure, centrifugation, or heating. Food products that may utilize such isolated/extracted sunflower protein include meat substitutes, soy substitutes, etc.

The protein isolated/extracted from sunflower seeds and/or other materials isolated/extracted from sunflower seeds using the processes disclosed herein may be used for adding nutrition to food products (e.g., enhancing protein content of food products). The nutritional component may include the addition of protein and/or other components of the sunflower seed such as phenols, phytic acid, chlorogenic acid, and/or the like. The isolated/extracted components may be understood to be nutraceuticals.

Other uses may include bakery uses (e.g., yeast raised and/or chemically leavened products), cereals, puff snacks, meat analogs, toffees, nougats, chocolate items, protein bits, gluten free flour blends, batters, coatings, etc.

### Example 11—Plant-Based Cheese

Soluble protein was isolated/extracted from sunflower seeds using the processes disclosed herein.

Percentages given are percentages by weight relative to all starting materials.

In order to formulate a plant based cheese, almond milk (31.8%), coconut oil (5.2%), potato starch (5.2%), tapioca flour (4.0%), soluble protein isolated/extracted from sunflower seeds (2.0%), nutritional yeast (1.6%), xanthan gum (0.1%), and salt (0.6%) were combined in a blender and blended until the mixture was creamy. This process formed an almond milk mixture.

In a small saucepan, water (45.7%) was combined with agar (3.9%) and cooked on medium low heat until the agar was dissolved. The saucepan was then covered, the heat was dropped to low, and cooked another 2 minutes, stirring occasionally, until the mixture was very thick. This process formed an agar mixture.

One half of the almond milk mixture was added to the agar mixture, mixing quickly. Then the remaining almond milk mixture was added while mixing continuously. The combination was mixed continuously over medium-low heat until cheese detached from the sides of the pot without sticking, approximately 5-10 minutes.

The cheese was then put in a glass container and refrigerated for at least 6 hours prior to slicing and/or shredding.

### Example 12—Plant-Based Ice Cream

Insoluble and soluble protein were isolated/extracted from sunflower seeds using the processes disclosed herein.

Percentages given are percentages by weight relative to all starting materials.

In order to formulate a plant based ice cream, water (22.2%), insoluble protein isolated/extracted from sunflower seeds (4.0%), soluble protein isolated/extracted from sunflower seeds (2.0%), GRINDSTED stabilizer blend (0.4%), and pea starch (1%) were combined in mixed thoroughly with strong agitation until fully incorporated. Almond milk (30%), a coconut water blend (14%), sugar (6%), and allulose (10%) were added and mixed thoroughly. Sunflower oil (10%) was added and agitated with a strong impeller type agitator/mixer to form an emulsion. The emulsion was heated on slow heat while stirring to 163 degrees F. (73 degrees C.). The emulsion was then cooled rapidly with agitation using an ice bath to a temperature less than 70 degrees F.

The cooled mixture was then placed in a precooled ice cream maker (Breville BCI600) and frozen in the ice cream machine with agitation until semi hard consistency (overrun target was 30%). The ice cream can be hardened in a standard freezer.

### Example 13—Extraction of Albumin, Chlorogenic Acid (CGA), Phytic Acid, and Helianthin from Sunflower Seeds

Sunflower seeds were obtained from a commercial source. The sunflower seeds were dehulled, cold-pressed and milled. The dehulled, pressed, and milled seeds contained 33% protein, 25% oil, 2% CGA, and 3.8% phytic acid. The milled material underwent an extraction process substantially as disclosed herein with reference to FIG. 4. In doing so, albumin, chlorogenic acid, phytic acid and helianthinin were isolated from the sunflower seeds.

The milled seeds were mixed with water at a 10:1 water to dry weight ratio, with NaCl added to make a 0.5M NaCl solution, heated to 138F and mixed for 2 hours. After 2 hours, the slurry was separated using a decanting centrifuge. The solids stream was mixed with water at 10:1 water to dry weight ratio and decanted again with the liquid stream from the first and second decanter combined. The solids stream was dried to form a sunflower meal. The liquid stream was mixed with CaCl₂) at 3.86 wt % of the meal in the initial extraction slurry. The pH was then raised to 5.8 with NaOH and then sent to a three phase disk stack centrifuge where an oil/oil:water emulsion was recovered as the light stream, a protein (albumins and helianthinin) and CGA containing aqueous stream was recovered and a wet solids stream was discharged. The solids stream contains >99% of the phytic acid from the extraction stream. The aqueous stream was sent to a 0.2-micron microfiltration membrane and diafiltration water was added after concentrating the stream to a factor of four. Diafiltration water was added at 0.25 times the volume of the initial volume of the stream sent to the membrane. The retentate was composed of large particles (primarily sunflower meal and the oil that did not get separated in the disk stack centrifuge) while the clarified permeate contained the proteins and the CGA. The permeate was subsequently sent to a 30 kDa ultrafiltration membrane. The retentate was concentrated to a factor of 5 of the starting volume and diafiltration water was added at 0.5 times the volume of the material sent to the ultrafiltration membrane. The retentate contained the helianthinin and the permeate contained the albumins and the CGA. The retentate was sent to an evaporator to concentrate the solids to 15% before going to a flash dryer to create a dry, insoluble sunflower protein powder that is 90 wt % protein. The permeate was sent to a 1 kDa ultrafiltration membrane. The retentate was concentrated to a factor of 10 of the starting volume and diafiltration water was added at 0.5 times the volume of the material sent to the membrane. The retentate contained the albumins and the permeate contained the CGA. The retentate was sent to an evaporator to concentrate the solids to 40 wt % before going to a spray dryer to create a dry, soluble sunflower protein that was 90 wt % protein. The permeate was sent to a 300 Da nanofiltration membrane and concentrated to a factor of 20. Diafiltration water was added at 0.25 times the volume of the material sent to the membrane. The permeate primarily contained NaCl and the retentate comprised the CGA. The CGA heavy retentate was sent to an evaporator to concentrate to 10% solids before going to a spray dryer where a dry, CGA powder as produced that is 60 wt % CGA.

In some instances, the aqueous phase 34 can be mixed with a divalent ion such as calcium chloride (CaCl₂). When doing so, the calcium ions may bind with phytic acid that may be present in the aqueous phase 34, resulting in an insoluble compound that may precipitate. The resulting solid/precipitate can be separated with a suitable separation apparatus such as a centrifuge, a filter, and/or the like. The collected solid (e.g., phytic acid) can be dried, for example using a suitable process such as those disclosed herein.

Adding the divalent ion at specific amounts in relation to the starting material results in different levels of phytic acid in the final soluble protein product. As an example, when the feed to the extraction step is 33% protein, 25% oil, 2% CGA, and 3.8% phytic acid and when the divalent ion is calcium chloride, adding the calcium chloride at the levels shown in the Table 1 (as disclosed herein) will result in the associated levels of phytic acid in the soluble protein product.

### Example 14—Phytic Acid Content/Removal

The sweetness level of the sunflower soluble protein can be modulated by the amount of phytic acid (PA) that remains in the powder. When the PA content is 4 wt % (dry matter basis) of the protein powder, its sweetness is reduced by 20% compared to the base protein powder which is 0.28 wt % PA. When the PA content is 7.7 wt % (dry matter basis) of the protein powder, its sweetness is reduced by 60% compared to the base protein powder. Phytic acid on it is on has no noticeable flavor.

PA content in the protein powder can be controlled by tuning the removal of PA from the process. If PA was not removed at all, the PA content in the final protein powder can be as high as 40 wt %. With the removal process, it can be modulated to 0.1-40.0 wt % of the final powder.

The base protein powder, which had 0.28 wt % phytic acid, is 10× sweeter than sucrose when comparing at a 0.5 wt % solution. When the protein solution has phytic acid included at 4 wt % of the protein powder, the sweetness compared to sucrose is only 2.5× sweeter. Having phytic acid levels at even higher levels, up to 8 wt %, will reduce the sweetness further as indicated herein.

This unique feature of the interplay between phytic acid and the sunflower albumin protein allows us to modulate the sweetness of the protein to the desired application. For instance, an alternative sweetener may be desired that allows the sucrose levels in a product to be substantially reduced. This would be a good application for the 10× sweet protein. In an alternative application, a higher level of protein may be desired which would require the protein product to be less sweet so as to allow more protein to be included without having overwhelming sweetness. This would be a good application for the product that has phytic acid included at levels up to 8 wt %.

TABLE 4
Compositional Information

| | Protein wt % | Phytic acid wt % |
|---|---|---|
| Sample | (dry basis) | (dry basis) |
| Control | 99.0 | 0.28 |
| Control + 4% phytic acid | 91.7 | 4.0 |
| Control + 7.7% phytic acid | 91.7 | 7.7 |

Phytic acid is naturally occurring in dehulled sunflower seeds at 2-3 wt %. The protein is at 20-25 wt % in the dehulled seed, with the soluble protein fraction at 4.0-6.25 wt %. Through the process of extracting and purifying the soluble protein, the soluble protein and PA can be at a ratio of as high as 4:3 (protein to PA) prior to removing the PA from the system.

The PA removal is performed by adding Calcium Chloride to the system at a molar ratio to the phytic acid of 6:1 or greater to remove all of the PA. The pH is adjusted to 5.5 or greater which causes the PA to precipitate. This precipitate can then be removed by a filter or a centrifuge. What remains is protein and a combination of sodium chloride, hydrogen chloride, and any excess calcium chloride. These non-protein compounds can then be removed by utilizing nanofiltration. In some instances, calcium chloride at a molar ratio to phytic acid (e.g., in the permeate) is about 5.6-6.0:1.

To modulate the amount of PA in the final powder, the amount of calcium chloride added to the system can be adjusted so that only a certain amount of PA is removed. By measuring the precise amount of phytic acid and protein in the system (which can be done with analytical instrumentation), the final protein and PA contents in the final product can be controlled and hence the sweetness level in the final product can be controlled.

### Example 15—Protein Enhanced Chocolate Milk

Soluble protein was isolated/extracted from sunflower seeds using the processes disclosed herein.

Percentages given are percentages by weight relative to all starting materials.

Three different protein enhanced chocolate milk products were formed. Each of the products included coca (1.5%), calcium carbonate (0.5%), cellulose gel (0.3%), natural and artificial flavoring (0.2%), salt (0.15%), carrageenan (0.1%), and cellulose gum (0.1%).

Protein enhanced chocolate milk formulation A also included 1% milk (92.75%) and a soluble protein isolated/extracted from sunflower seeds (4.4%) having a sweetness approximately equal to sucrose and containing 6 wt % phytic acid.

Protein enhanced chocolate milk formulation B also included 1% milk (94.98%) and a soluble protein isolated/extracted from sunflower seeds (2.17%) having a sweetness approximately 2 times the sweetness of sucrose and containing 4 wt % phytic acid.

Protein enhanced chocolate milk formulation C also included 1% milk (96.35%) and a soluble protein isolated/extracted from sunflower seeds (0.8%) having a sweetness approximately 5 times the sweetness of sucrose and containing 2 wt % phytic acid.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

1-38. (canceled)

39. A method for extracting a plurality of target materials from oil seeds, the method comprising:
performing an extraction on an oil seed material to form an aqueous phase and a solid phase, wherein the extraction is performed in an organic solvent-free extraction at a pH of 5-8;
separating the insoluble solids from the aqueous phase filtering the aqueous phase into a retentate and a permeate; and
drying the retentate.

40. The method of claim 39, wherein the retentate has a sweetness that is sweeter than a sweetness of sucrose.

41. The method of claim 39, wherein the retentate has a sweetness that is 2-10 times sweeter than a sweetness of sucrose.

42. The method of claim 39, wherein the retentate has a sweetness that is 2-5 times sweeter than a sweetness of sucrose.

43. A method for extracting materials from oil seeds, the method comprising:
mixing an extraction solution to a quantity of dehulled, cold-pressed, and milled oil seeds to form a mixture;
wherein the extraction solution includes water and a salt;
wherein the extraction solution has a pH of 5-8;
extracting the mixture at a temperature in the range of 10-93° C. for 0.5 to 6 hours to form an extracted mixture having an aqueous phase;
separating the insoluble solids from the aqueous phase using a separation process;
lowering the pH to 4.0-4.5 of the permeate to create a precipitate
filtering the lowered pH material to form a retentate and a permeate;
drying the retentate to form a dried retentate, wherein the dried retentate comprises a first target material;
filtering the permeate to form a second retentate and a second permeate;
drying the second retentate to form a dried second retentate, wherein the dried second retentate comprises a second target material;
filtering the second permeate to form a third retentate;
drying the third retentate to form a dried third retentate, wherein the dried third retentate comprises a third target material.

44. The method of claim 43, wherein the first target material includes a protein.

45. The method of claim 43, wherein the second target material includes a second protein fraction.

46. The method of claim 43, further comprising adding a precipitating material to the aqueous phase to form a second precipitate.

47. The method of claim 46, wherein the second precipitate includes phytic acid.

48. The method of claim 46, wherein the precipitating material is calcium chloride.

49. The method of claim 46, wherein adding a precipitating material to the permeate to form a precipitate includes adding calcium chloride at a molar ratio to phytic acid in the permeate at 5.6-6.0:1.

50. The method of claim 43, wherein the third target material includes chlorogenic acid.

51. A composition, comprising:
a first component comprising a sunflower protein extract that is isolated from sunflower seeds after one or more extraction processes, wherein at least some of the one or more extraction processes includes extraction at a pH of 5-8; and
a second component comprising phytic acid.

52. The composition of claim 51, wherein the first component comprises 91.7-99 weight-% of the composition.

53. The composition of claim 51, wherein the second component comprises 0.28-7.7 weight-% of the composition.

54. The composition of claim 51, wherein the second component comprises 2-6 weight-% of the composition.

55. The composition of claim 51, wherein the composition has a sweetness that is substantially equal to a sweetness of sucrose.

56. The composition of claim 51, wherein the composition has a sweetness that is sweeter than a sweetness of sucrose.

57. The composition of claim 51, wherein the composition has a sweetness that is 2-10 times sweeter than a sweetness of sucrose.

58. The composition of claim 51, wherein the composition has a sweetness that is 2-5 times sweeter than a sweetness of sucrose.
